(19) United States
(12) Patent Application Publication
(10) Pub. No.: US 2008/0015880 A1
(43) Pub. Date: Jan. 17, 2008

(54) System, Method, and Software for a Business Acquisition Management Solution

(75) Inventors: Philip J. Freedenberg, Canton, CT (US); Samir Kumar, Bristow, VA (US); Susan J. Wright, Raleigh, NC (US); Mahesh Santhanam, Fairfax, VA (US); Vinod K. Veturi, Bentonville, AR (US)

Correspondence Address: BAKER BOTTS L.L.P., 2001 ROSS AVENUE, SUITE 600, DALLAS, TX, 75201-2980, US

(73) Assignee: BearingPoint, Inc., McLean, VA (US)

(21) Appl. No.: 11/748,419

(22) Filed: May 14, 2007

Related U.S. Application Data
(60) Provisional application No. 60/800,565, filed on May 12, 2006.

(51) Int. Cl. G06Q 10/00; G06F 17/30

(52) U.S. Cl. 705/1

(57) ABSTRACT

A system for managing business acquisitions includes a memory module storing information in one or more business objects associated with managing a business acquisition. The system includes a server system having a composite application providing processes for managing the business acquisition, the composite application providing an integrated solution for managing the business acquisition. The processes include: (1) a capture opportunity process for facilitating establishment and approval of an opportunity; (2) a pursuit planning process for facilitating development and approval of a proposal development schedule; (3) a solicitation planning process for facilitating, in response to receipt of a customer solicitation in one of various forms, updating of the proposal development schedule, establishment of a collaborative environment for preparing a proposal for the opportunity, and approval of a decision to bid on the opportunity; (4) a proposal development process for facilitating preparation of content of the proposal for the opportunity; and (5) a contract negotiation process for facilitating finalization of a statement of work for the project. The composite application is a web-based application receives, from one or more users associated with the business acquisition, input and documents for the one or more processes, and facilitates storage of the input and documents in association with the one or more business objects stored in the memory module.

### RELATED APPLICATION

This application claims the benefit under 35 U.S.C. §119(e) of U.S. Provisional Application No. 60/800,565, entitled, “System, Method, and Software for a Business Acquisition Management Solution,” filed on May 12, 2006.

### TECHNICAL FIELD

The present invention relates generally to business management and systems integration and more particularly to a system, method, and software for a business acquisition management solution.

### BACKGROUND

Enterprises and other suitable business entities frequently seek to gain new business or to develop existing business. As an example, an enterprise may wish to pursue new business in response to an external request (e.g., a Request for Information (RFI), a Request for Proposal (RFP), or a Request for Quote (RFQ), collectively RFx), proactively from a directive inside the enterprise, or both. In most enterprises, the business acquisition (e.g., capture and bid-and-proposal processes) are dynamic, fluid, expensively-managed, and very “noisy” processes. Many enterprises have not formally documented the proposal development process. Instead, proposal managers frequently rely on mentors and passed-along knowledge during the proposal development process. To complicate matters, many enterprises use different procedures in each of their branches or lines of business. Moreover, many enterprises are not able to effectively leverage other information technology (IT) investments in the business acquisition process.

### SUMMARY

According to the present invention, disadvantages and problems associated with previous techniques for the managing business acquisitions may be reduced or eliminated.

In certain embodiments, A system for managing business acquisitions includes a memory module storing information in one or more business objects associated with managing a business acquisition. The system includes a server system having a composite application providing processes for managing the business acquisition, the composite application providing an integrated solution for managing the business acquisition. The processes include: (1) a capture opportunity process for facilitating establishment and approval of an opportunity; (2) a pursuit planning process for facilitating development and approval of a proposal development schedule; (3) a solicitation planning process for facilitating, in response to receipt of a customer solicitation in one of various forms, updating of the proposal development schedule, establishment of a collaborative environment for preparing a proposal for the opportunity, and approval of a decision to bid on the opportunity; (4) a proposal development process for facilitating preparation of content of the proposal for the opportunity; and (5) a contract negotiation process for facilitating finalization of a statement of work for the project. The composite application is a web-based application receives, from one or more users associated with the business acquisition, input and documents for the one or more processes, and facilitates storage of the input and documents in association with the one or more business objects stored in the memory module.

Particular embodiments of the present invention may provide one or more technical advantages. In certain embodiments, the present invention provides an collaborative, structured, and integrated environment for capture and bid-and-proposal processes. The present invention may help an entity (e.g., a contractor) to integrate teams and schedules, drive repeatability and consistency to leverage resources more effectively in the bidding process, and incorporate lessons learned from each acquisition to improve its overall win rate. In certain embodiments, the present invention supports the tracking of new business opportunities; structures pursuit planning, solicitation response planning, and proposal development, and incorporates lessons learned from each acquisition to improve an enterprise's overall win rate.

In certain embodiments, the present invention provides a documented, efficient, and repeatable process that encompasses the structural mechanics of the capture and bid-and-proposal effort, which may enable a proposal manager and a capture manager to concentrate on the proposal content and the team needed to win the business opportunity and to deliver the work. The present invention may use industry-leading practices, integrate collaboration tools, and leverage existing business systems. For example, the present invention may be integrated into an enterprise's legacy enterprise resource planning and business systems.

In certain embodiments, the present invention facilitates collaboration among employees of the enterprise in the bid-and-proposal process. In certain embodiments, the present invention brings together a set of tested delivery assets and leading practices using common language, methods, and templates across the complete life cycle of a bid-and-proposal project. In certain embodiments, the present invention drives repeatability and consistency in the business acquisition process to leverage resources. For example, the present invention may allow many or all of an enterprise's business development groups to follow a similar process for identifying and qualifying new business opportunities and generating responses to solicitation. Aligning the business acquisition function in one repeatable process may optimize an enterprise's (e.g., a contractor's) ability to act rapidly on emerging opportunities, increase communication between sectors, and better leverage resources across the enterprise.

In certain embodiments, the present invention integrates teams and schedules. For example, the present invention may integrate with one or more backend systems, such as backend human resources, sales, project management, and material management applications, to aid in identification of team members, key partners, and suppliers, as well as to build proposal and execution project schedules. The present invention may also track opportunities stemming from individual customers.

In certain embodiments, by institutionalizing processes into formal stage-gate reviews, by creating collaborative environments for multi-partner teaming arrangements, and through other features, the present invention may enable an enterprise to respond to formal solicitations in a faster, less-costly, and less-risky way than with previous and existing solutions. As a composite application, the present invention may address a gap in business requirements. The gap resolution is an overarching application that goes beyond functional silos, organization boundaries, and includes a number of roles for developing and capturing new business where formal bids may be used.

The present invention may streamline and standardize the approach of tracking opportunities and documenting the entire proposal development process, while remaining independent of the back-end business management systems. The present invention may aid in understanding trends and statistics around the capture management process, which may lead to improved proposal win rates.

In certain embodiments, the present invention may automates milestones and checks and approvals. The present invention may create an audit trail, which may be important for demonstrating regulatory compliance/accountability.

Certain embodiments of the present invention may provide some, all, or none of the above advantages. Certain embodiments may provide one or more other technical advantages, one or more of which may be readily apparent to those skilled in the art from the figures, descriptions, and claims included herein.

### BRIEF DESCRIPTION OF THE DRAWINGS

For a more complete understanding of the present invention and its advantages, reference is made to the following descriptions, taken in conjunction with the accompanying drawings, in which:

FIG. 1 illustrates an example system for a managing business acquisitions, according to certain embodiments of the present invention;

FIG. 2 illustrates an example process for managing business acquisitions, according to certain embodiments of the present invention;

FIGS. 3A-3F illustrates a more detailed example process for managing business acquisitions, according to certain embodiments of the present invention;

FIG. 4 illustrates another view of an example process for a business acquisition management solution, according to certain embodiments of the present invention;

FIG. 5 illustrates an example business acquisition management solution (BAMS) logical architecture according to certain embodiments of the present invention; and

FIG. 6 illustrates an example object model of example business objects that may be defined for the BAMS tool, according to certain embodiments of the present invention.

### DESCRIPTION OF EXAMPLE EMBODIMENTS

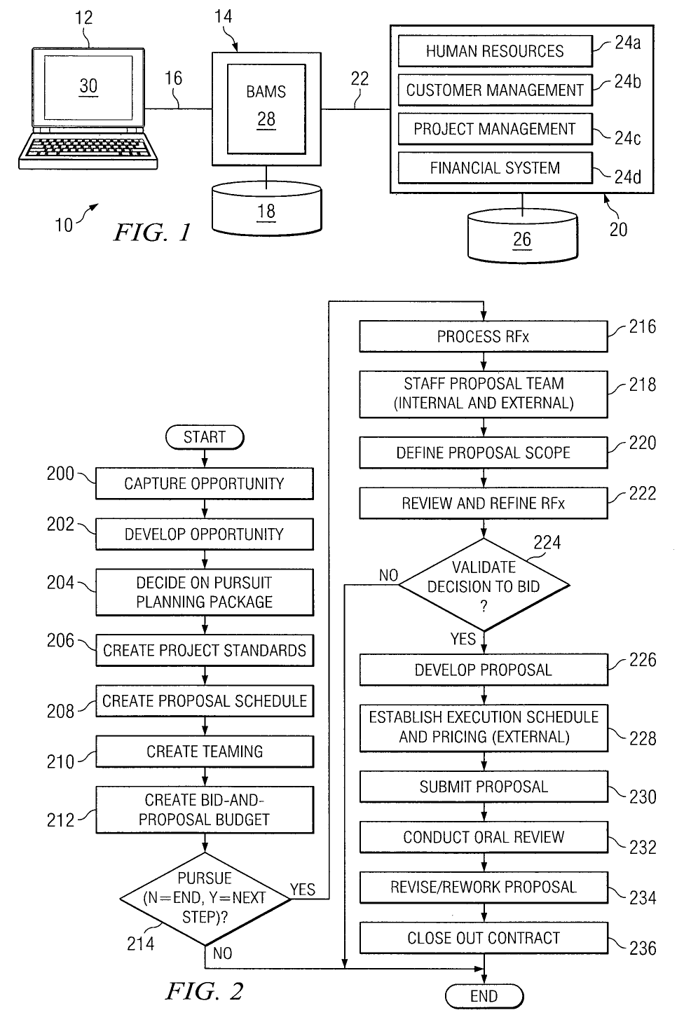

FIG. 1 illustrates an example system 10 for a managing business acquisitions, according to certain embodiments of the present invention. System 10 includes one or more user systems 12 coupled to a server system 14 via a link 16. Although this particular implementation of system 10 is illustrated and primarily described, the present invention contemplates any suitable implementation of system 10 according to particular needs.

In general, system 10 provides an integrated solution for managing the business acquisitions of an enterprise. For purposes of this description, an enterprise refers to a business entity (including a governmental entity) of any size. As used throughout this description, a business acquisition refers to the acquisition by a first enterprise of the opportunity to sell products and/or services to another enterprise, which may be a new or existing client. In one example, a business acquisition is a contract for a first enterprise (the acquirer of the business) to provide products and/or services to another enterprise. A business acquisition include the process by which a business opportunity is identified through the bid-and-proposal process.

System 10 may include one or more user systems 12. For simplicity, throughout this description, one or more user systems 12 will be referred to primarily in the singular. Moreover, “user system 12” and “user of user system 12” may be used interchangeably. User systems 12 may be associated with an enterprise, such as an enterprise seeking to acquire business or an enterprise in a third-party relationship with an enterprise seeking to acquire business. Users of user system 12 may include various employees of the enterprise, employees of a third party providing services to the enterprise, or any other suitable users according to particular needs. User system 12 may include any appropriate input devices, output devices, mass storage media, processors, memory, or other suitable components for receiving, processing, storing, and communicating information. Each user system 12 may operate using a different user platform, or two or more user systems 12 may operate using identical user platforms. As an example, user system 12 may include a personal computer, such as a conventional desktop or laptop computer.

Although one user system 12 is illustrated, the present invention contemplates system 10 including any suitable number of user systems 12 according to particular needs. For example, in one embodiment, server system 14 is coupled to multiple distributed user systems 12. User systems 12 may be physically distributed, being in different physical locations geographically remote from each other and from server system 14, or logically distributed, being at approximately the same location as other user systems 12 and server system 14. Each user system 12 may be coupled to server system 14 via one or more links 16 (referred to hereinafter in the singular).

Server system 14 includes one or more electronic computing devices operable to receive, transmit, process, and store data associated with system 10. For example, server system 14 may include a single server computer or multiple server computers (e.g., a pool of servers). In one embodiment, server system 14 may accept input from user system 12 via a web browser and return appropriate HTML pages. Server system 14 may store one or more applications that are accessible to user system 12. These applications may include client-server applications, for example.

Server system 14 may include or may be otherwise coupled to one or more databases 18, each of which may include any memory module and may take the form of volatile or non-volatile memory including, without limitation, magnetic media, optical media, random access memory (RAM), read-only memory (ROM), removable media, or any other suitable local or memory component. For simplicity, the one or more databases 18 will be referred to throughout this description in the singular. In certain embodiments, database 18 includes one or more SQL servers.

System 10 may include one or more backend server systems 20 coupled to server system 14 via one or more links 22 (referred to hereinafter in the singular). Backend server system 20 may include one or more electronic computing devices operable to receive, transmit, process, and store data associated with system 10. Although backend server system 20 is described as being separate from server system 14, the present invention contemplates server system 14 and backend server system 20 being the same server system (in whole or in part).

Backend server system 20 may store and execute one or more backend services 24. Example backend services 24 may include human resources system 24a, customer management system 24b, project management system 24c (which may include one or more of a production processes system, a material management system, and a pricing engine system), and a financial system 24d. These example backend services 24 are provided merely as examples. System 10 may include some, none, or all of these example backend services 24, as well as any other suitable backend services 24. Each of these backend systems 24 may be implemented in any suitable combination of firmware, software, and hardware. Backend services 24 may be heterogeneous. For example, backend services 24 may be provided by a variety of software providers.

Some or all of backend services 24 may be associated with a corresponding web service. A web service corresponding to a backend service 24 is published in that it is available to other applications (e.g., applications of server system 14) and allows those applications access functionality and data associated with the corresponding backend service 24. In certain embodiments, these web services may be published from backend services 24 using standardized Internet protocols, such as SOAP, WSDL, and UDDI.

Various data may be stored in association with backend services 24. This data may be stored in one or more databases 26 accessible to backend server system 20. Each of the one or more databases 26 may include any memory module and may take the form of volatile or non-volatile memory including, without limitation, magnetic media, optical media, random access memory (RAM), read-only memory (ROM), removable media, or any other suitable local or memory component. For simplicity, the one or more databases 26 will be referred to throughout this description in the singular. In certain embodiments, database 26 includes one or more SQL servers. The one or more database 26 may or may not be a part of databases 18.

In certain embodiments, database 26 stores one or more of the following: human resources master data (e.g., employee-related data from human resources system 24a, such as Employee ID, First Name, Last Name, Email, Position, Skills, and Rate); customer data (e.g., customer-related data from a backend Enterprise Resource Planning (ERP) system, such as Customer ID, Name, Country, City, State, Street, and Email); employee assignment data (e.g., assignment of employees to specific events or tasks, and including Employee ID, Start Date, and Finish Date); capability master data (e.g., capabilities that are needed to perform tasks; may be used to identify areas for partnership and includes Capability ID, Capability Name, Description, Capability Category, Category Name, and Category Description); vendor data by capability (e.g., information about vendors and partners and the capability provided by them; includes Vendor ID, Name, Capability ID, and Capability Name); skills data by employee (e.g., skill data stored for each employee; may be used to assign employees according to requirements and their skill and includes Skills ID, Skills Name, and Employee ID); position data by skills (e.g., positions defined by HR system, and includes Position ID, Description, Skills, and Rate); material master data (e.g., material-related information, including Material Number, Description, Unit of Measure, and Unit Price); and/or any other suitable data.

User system 12, server system 14, database 18, backend server system 20, and database 26 may each include an appropriate combination of hardware, firmware, and software associated with one or more computer systems at one or more locations. These components of system 10 may share data storage, communications, or other resources according to particular needs. Each computer system may include one or more suitable input devices, output devices, mass storage media, processors, memory, or other components for receiving, processing, storing, and communicating information according to the operation of system 10.

Links 16 and 22 may include one or more computer buses, local area networks (LANs), metropolitan area networks (MANs), wide area networks (WANs), a global computer network such as the Internet, or any other wireline, optical, wireless, or other links. Links 16 and 22 may communicate, for example, IP packets, Frame Relay frames, or Asynchronous Transfer Mode (ATM) cells to communicate voice, video, data, and other suitable information between network addresses.

Server system 10 supports a business acquisition management solution (BAMS) tool 28. BAMS tool 28 may be a web-enabled software application, although the present invention contemplates BAMS tool 28 being implemented in any suitable manner. User systems 12 may interact with BAMS tool 28 using a graphical user interface (GUI) 30 such as may be associated with a web browser or other portal. Users of user systems 12 may provide input and documents into GUI 30, and server system 14 may store and manipulate the information in database 18. Any other type of interface could be used without departing from the scope of the invention.

In general, BAMS tool 28 is an business process-based application that standardizes and streamlines the business acquisition process. In certain embodiments, the business process that is implemented by BAMS tool 28 is a process for business acquisitions (an example of which is described in more detail below with reference to FIGS. 2-4). This business acquisition process may include five high-level business processes. These high-level processes are a Capture Opportunity process, a Pursuit Planning process, a Solicitation Planning process, a Proposal Development process, and a Contract Negotiation process. Each of these processes may be followed by an executive review, which may facilitate documentation of decisions throughout the business process. Each of the five high-level business processes may include one or more sub-processes that may be performed by various roles. BAMS tool 28 may walk users of user systems 12 (e.g., via a GUI) through the bid-and-proposal process using guided procedures based on the business processes.

With previous and existing solutions for business acquisition management, information may be distributed in many functional silos and frequently may not be accessible in a sufficient manner, time may be wasted by not having a common platform on which to interact, visibility of relevant documentation may not be provided, and no integrated system landscape for supporting efficiency may exist.

In contrast, BAMS tool 28 may support collaboration between virtual teams of enterprises, business units, organizations and their partners, and suppliers using portal-based roles and a knowledge management folder structure to help organize work. BAMS tool 28 may produce fully resource-loaded project management schedule to support both the proposal process and input for pricing analysis. Executive review points support the progression of the proposal process to ensure the enterprise pursues the right opportunities. BAMS tool 28 may bridge the human resource, materials, project management, and sales/CRM back-end systems (e.g., backend services 24) to the proposal environment, to permit more accurate planning and execution of proposal efforts. BAMS tool 28 may standardize the approach to responding to proposals, so the team can concentrate on the variability of the approach and content. BAMS tool 28 may streamline and standardize the approach of tracking opportunities and documenting the entire proposal development process, while remaining independent of the back-end business management systems (e.g., backend systems 24). These and other features of certain embodiments of the present invention are described in more detail below.

BAMS tool 28 may be implemented in any suitable combination of software, firmware, and hardware. In certain embodiments, BAMS tool 28 is a composite application. A composite application is a user-centric application supporting highly collaborative dynamic business processes which span several functional areas across and beyond organizations. Composite applications are typically built and deployed on top of existing service operations (e.g., web services) supplied by backend components (e.g., backend services 24). Composite applications may combine these service operations with new application logic, user interfaces, and business process orchestration. Composite applications make use of data and functions provided as services by platforms and applications, combining these into user-centric processes and views, supported by their own business logic and user interfaces.

Composite applications may be loosely coupled to the components on which they are based, which may result in a new logical application tier. Thus, in some cases, composite applications may be deployed independent of the backend services (e.g., backend services 24). Composite applications may allow enterprises to leverage existing investment in IT, such as the investment in backend services 24, and to respond efficiently to the ever-changing business environment.

In a particular example, BAMS tool 28 is a composite application that is developed using the SAP Composite Application Framework (CAF) and is compatible with SAP's NETWEAVER integration tools. Composite applications may be able to bridge many disparate systems (e.g., backend services 24) by using NETWEAVER integration tools, such as portals, web services, Exchange Infrastructure (XI), and collaboration tools such as knowledge management. In certain embodiments, BAMS tool 28 may be provided to user system 12 as a web service. Although BAMS tool 28 is described primarily as an SAP-based solution, BAMS tool 28 may be implemented with any suitable architecture, such as any suitable Service Oriented Architecture.

BAMS tool 28 may implement one or more of the following components: a process flow, one or more roles, one or more business objects, a user interface, logging/auditing capabilities, and a reporting capability.

Process Flow

BAMS tool 28 implements a process for managing business acquisitions. An example process for managing business acquisitions is described in more detail below with reference to FIGS. 2-4).

Roles

BAMS tool 24 may use “roles” to assign tasks, control access to portions of BAMS tool 24, and for other suitable purposes. The following provide examples of the roles that may be implemented using BAMS tool 28 and the tasks performed by each role. These example roles and tasks are provided merely as examples. BAMS tool 28 may implement some, none, or all of these example roles and tasks, as well as any other suitable roles and tasks. Moreover, these example roles and tasks may be provided as defaults by BAMS tool 28; however, an appropriate user may be able to define additional/different roles and to reassign tasks as may be appropriate for a particular implementation.
Business Manager: Primary responsibility is to identify and capture opportunities from various sources of leads.
Capture Manager: Primary responsibility is to win the qualified opportunity. Responsible for development of client relationship and for providing business-related guidance to the proposal team.
Proposal Manager: Primary responsibility is to lead the proposal development effort with the proposal team.
Proposal Team: Primary responsibility is to support various proposal development tasks, such as writing content, collecting qualifications, partner relationships, pricing, etc.
Executive: Part of the Executive management team with a primary responsibility to provide oversight and review the contents of the proposal at the end of each business process.
Partner/Vendor: Primary responsibility is to provide proposal content based on the scope of work identified in the partner/vendor contract. The partners/vendors may have controlled access to BAMS tool 28 based on their need for collaboration on proposal content. In certain embodiments, partners/vendors may access BAMS tool 28 from outside a firewall of the enterprise.
   Business Objects

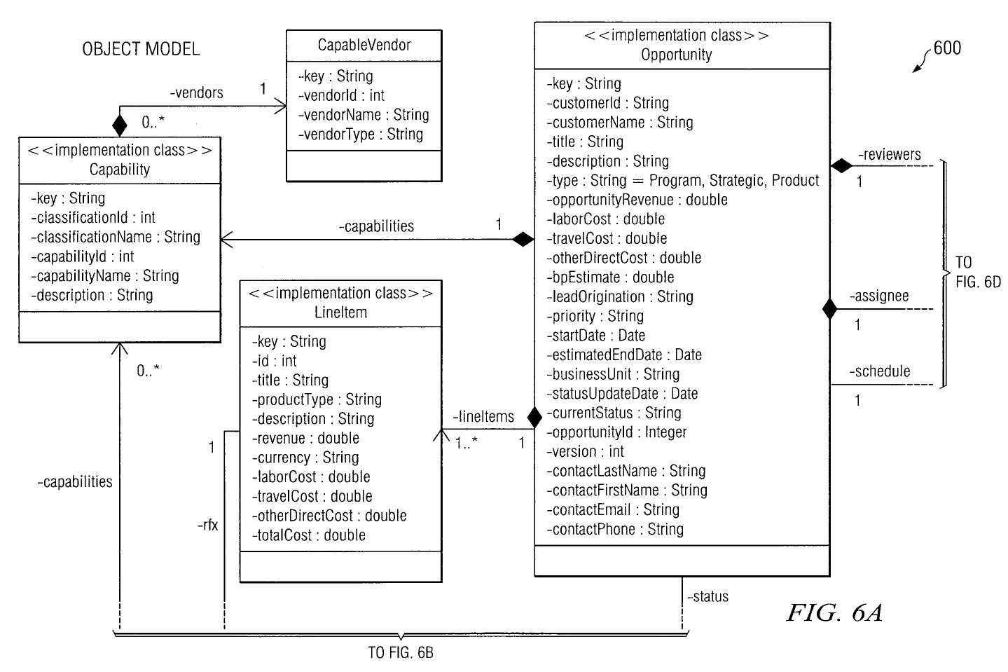

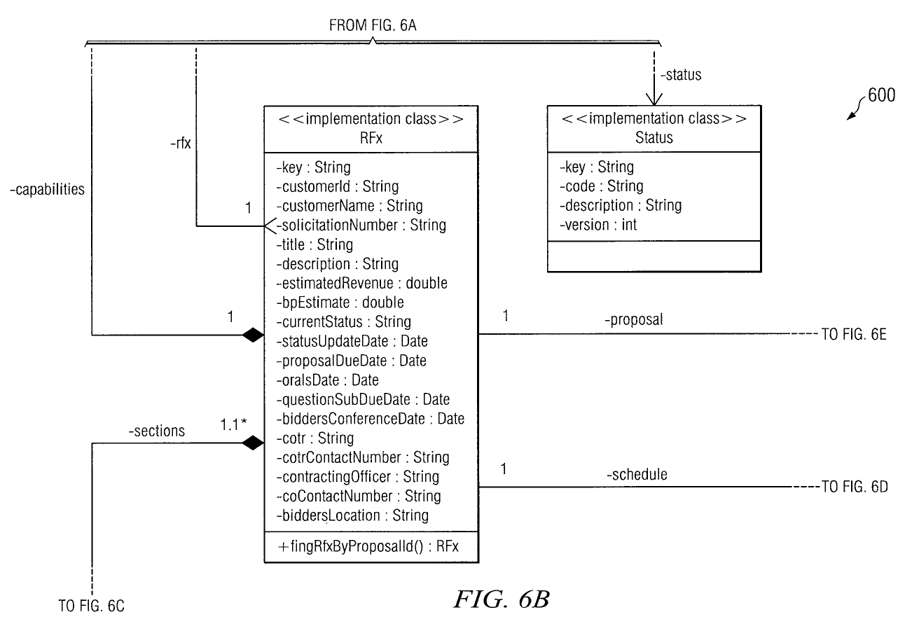

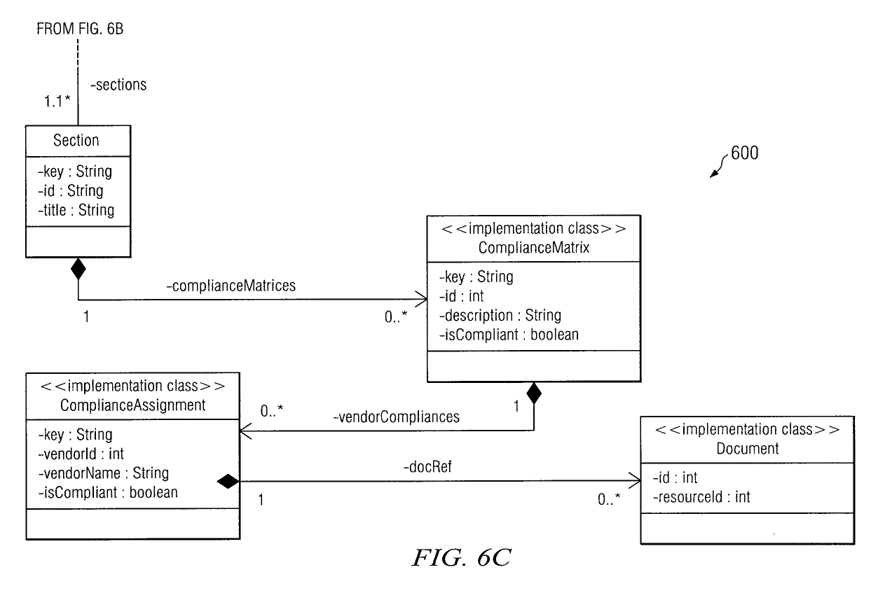

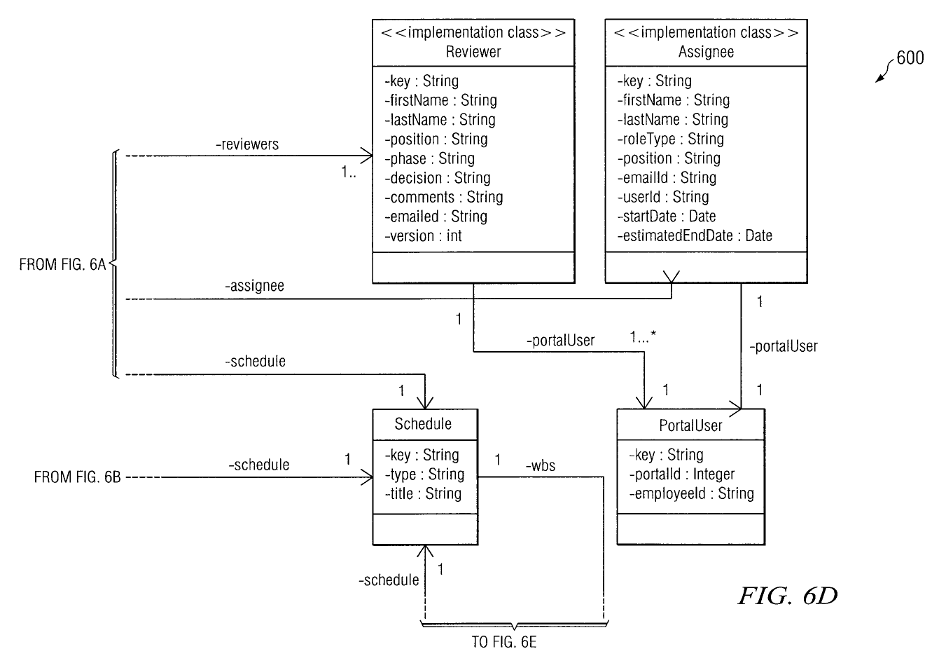

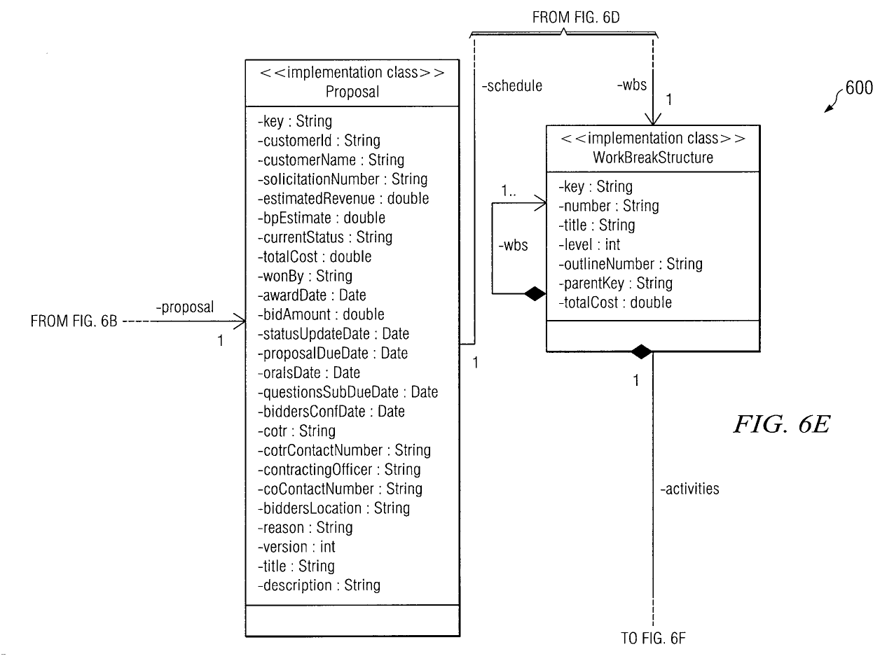

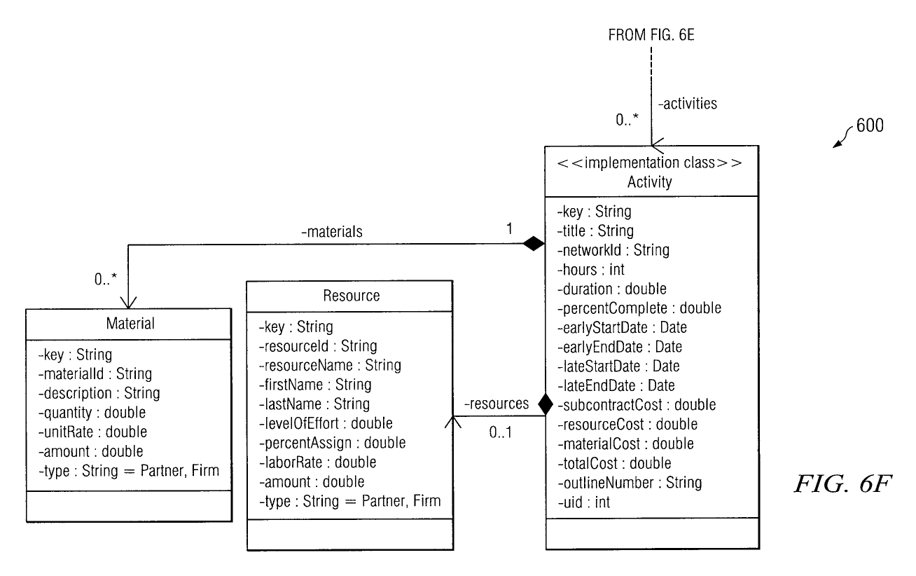

BAMS tool 28 may use a number of business objects that model various aspects of the business relevant to the business acquisition process. Example business objects may include an opportunity object, an RFx object, a proposal object, and any other suitable objects. Each object may be associated with one or more attributes and data elements. An example attribute may be the status of the business activity associated with the object. An example object model that may be used is described in more detail below with reference to FIG. 6.

User Interface

BAMS tool 28 may provide a user interface for with which a user of user system 12 may interact. The user interface may be delivered through a portal of the enterprise or in any other suitable manner, and may include GUI 30. The user interface of BAMS tool 28 may provide a user the ability to configure portions of the BAMS tool 28, depending on the user's roles and rights. The user interface of BAMS tool 28 may also guide a user through the business acquisition process.

In certain embodiments, the application logic of BAMS tool 28 may be decoupled from the user interface provided by BAMS tool 28 using a suitable user interface framework, such as SAP WEB DYNPRO and UI Patterns. In certain embodiments, BAMS tool 28 implements, in its design and development, the portal and knowledge management features for user-centric interface and document organization. In certain embodiments, the SAP Solution Manager may be used to document the BAMS process model and landscape. For examples, users may access portions of the user interface through a portal, perform functions exposed through the user interface, and access data through the user interface according to one or more defined roles.

The user interface may be defined based on system-level use cases. In one example, the user interface includes a tabbed view, allowing certain data to be visible at all times. The UIs of BAMS tool 28 may be developed using SAP WEB DYNPRO components with GP Interface. CAF core functions may be exposed as proxies for consumption by SAP WEB DYNPRO components. Document management may use SPA knowledge management APIs and may be wrapped in a WEB DYNPRO component.

Logging/Auditing Capabilities

BAMS tool 28 may provide various logging and auditing functions, which may provide regulatory compliance and promote accountability within the enterprise. The audit trail may be created by documenting the review processes implemented through the business acquisition process of BAMS tool 24.

Reporting Capability

In certain embodiments, BAMS tool 28 is operable to generate one or more reports. These reports may be generated automatically by BAMS tool 28 (according to appropriate configurations) or in response to a user request. In certain embodiments, some or all of the reports may be user-generated, dashboard-type reports. The reports may include, for example purposes only, an Opportunity Status Report, a Competitive Analysis Report, a Days Outstanding Report, and a Teaming History Report. Each of these example reports is discussed below.

The Opportunity Status Report provides budgetary and management information about an opportunity at any given time. BAMS tool 28 may be able to sort and/or filter this report by Capture Manager, Customer Name, Proposal Manager, Dates, and Opportunity Status. This report may be interactive and may include comments written by the Capture Manager and/or Proposal Manager. In certain embodiments, this report is generated weekly.

The Competitive Analysis Report provides information about the proposal and its winner. It may be used to analyze a competitor's strengths, for example. BAMS tool 28 may be able to sort this report by Solicitation Number, Winner, Award Date, Customer Name, Proposal Manager, and Capture Manager. In certain embodiments, this report is generated on an as-needed basis during the Pursuit Planning process.

The Days Outstanding Report provides the ability to search for dormant opportunities, so they may be updated with current status. In certain embodiments, this report is generated in response to a user request for opportunities with a status not equal to abandoned, won, or lost.

The Teaming History Report provides information about partner/supplier capabilities and details of proposals. BAMS tool 28 may be able to sort this report by Partner/Supplier Name, Opportunity Status, Proposal Name, Customer Name, Proposal Award Date, Capture Manager, and Proposal Manager. BAMS tool 28 may use stored historical information to generate the report. In certain embodiments, this report is generated on an as-needed basis during the New Opportunities phase.

The following provides various example implementation details according to an embodiment in which BAMS tool 28 is implemented using SAP's composite application framework.

CAF: Core, Guided Procedures, UI Patterns

In certain embodiments, classes from the object model are translated to CAF Core Entity Services, and attributes of a class in the object model are mapped to the attributes of the Entity Services. Create, Read, Update, and Delete (CRUD) operations may be automatically created with Entity Services. FindBy operations may be defined on the Entity Services. Application services may be logically grouped by business process phase (e.g., Opportunity, RFx, and Proposal phases). Business logic may be implemented in application services.

CAF Guided Procedure

Process, Block, Action, and Callable Object

The Guided Procedure for a business process may be defined. The Callable Object interface for application components (e.g., SAP WEB DYNPRO) may be implemented with GP Interface. Operations may be implemented on Application Services for some or all background actions (e.g., status updates). Input and output parameters may be consolidated at action, block, and process level. The roles for those actions that should be executed by the same user may be consolidated.

Integration

Various standalone JAVA components may be used, including knowledge management interfaces, MICROSOFT PROJECT API, and JAVA MAIL, for example. Knowledge management interfaces may be invoked directly as a callable object, or SAP WEB DYNPRO component using knowledge management libraries can be constructed and wrapped in a callable object. In certain embodiments, MICROSOFT projects are included in table structures using XML parsing APIs in an SAP WEB DYNPRO project. It may be possible to include other project management software handlers, as well. JAVA libraries such as JAVA MAIL may be invoked from deployed NETWEAVER applications.

Database 18 may store one or more tables for storing data generated throughout the business acquisition process. For example, as a user interacts with BAMS tool 28, data may be generated and stored in database 18 by BAMS tool 28. Moreover, a plurality of tables associated with the business objects may be stored in database 18. These tables may store values for the data elements and other attributes of these objects. Database 18 may store documents and other data related to the business acquisition process.

The following provides a description of the five high-level process steps (Capture Opportunity, Pursuit Planning, Solicitation Planning, Proposal Development, and Contract Negotiation), according to certain embodiments of the present invention. These descriptions are provided for example purposes only and should not be used to limit the scope of the present invention.

Capture Opportunity

Process Description:

The business acquisition management process starts with the qualification of a lead into an opportunity. The process may involve creating the opportunity and assigning roles to the opportunity. A Business Manager may create the opportunity, often with reference to a lead. The opportunity is created, assigned to a Capture Manager and Proposal Manager, populated with win themes and internal and external capabilities for internal business units or partner assignments. Further, a bid and proposal budget and projected revenue estimates are included on the opportunity. This information is routed to the Executive(s) for approval to pursue the opportunity.

The Capture Opportunity process may include querying one or more appropriate backend services 24 of backend server system 20 for the existence of the customer record for which the opportunity is being created. If no existing record is found, the opportunity is created using a pseudo-customer, and a notification is sent to the group responsible for creating the customer record in the appropriate backend service 24. The status of the opportunity may first be set to “Created” and is changed to “Assigned” when the Proposal Manager and/or Capture Manager are added. The availability of the Capture Manager and the Proposal Manager may be updated in human resources system 24a on backend server system 20.

Benefits:

Visible Process: Capturing all opportunities in a centralized system ensures that a common repository is developed and managed. Opportunity status information tracks the progress of each individual opportunity throughout its life cycle. Reviewing all open opportunities allows capture managers and executives to view the entire active pipeline. The review ensures that only the opportunities that are aligned with corporate mission and have high chance to succeed are further developed. This makes sure that the acquisition team spends resources on opportunities with higher probability of success.
Collaboration: All the documents related to the opportunity are stored and accessible from BAMS tool 28. The review process is managed, tracked, and expedited through the online review of the opportunity and related documents. The capture and proposal managers including authorized partners benefit by having a structured knowledge management environment tailored to the opportunity. Executives benefit by having a documented trail on approvals and decisions to pursue the opportunity.
System Integration: The assignment of the capture manager and proposal manager to the opportunity is done by using the human resource system to reflect the assignment of these resources. This ensures that available and qualified resources are assigned to the opportunity. This helps in more effectively managing resources required in the acquisition process. Customer data acquired from the back-end sales system ensures that one source of customer information is used and promotes data consistency across all the systems.
Storage and Reporting: BAMS tool 28 may create records of rework or dropped opportunities to aid in identifying possible issues with the quality, justification, viability, or initial opportunity selection. A single storage location ensures availability of documents for future proposal efforts. The system also provides an ability to track the decisions of the Executives and maintain executive comments on approval/disapproval in a central location.
   Benefits by Role:
Business Manager: BAMS tool 28 may provides a single structured system to store multiple opportunities and opportunity line items. This also allows the Business Manager to capture and track the progress of the portfolio of various opportunities during the acquisition process.
Capture Manager: BAMS tool 28 may provides a single repository to store the opportunity related documents such as capture plan, win theme, etc.
Proposal Manager: BAMS tool 28 may allow the Proposal Manager to store the opportunity related data such as the bid and proposal budget, and projected revenue from winning the opportunity. The Proposal Manager can also route an opportunity to the executive team for approval. The routing reduces the approval cycle time and also allows the Proposal Manager to track the progress of the executive review.
Executive: BAMS tool 28 may provide a single source to review the opportunity data and related documents. The portal-based architecture allows executives to access the system and view other executive decisions creating an executive peer review and collaboration environment. Approvals of win themes and capture plans are permanently stored with each opportunity to document executive level approvals or decisions to not pursue or rework the approach.
   Pursuit Planning
   Process Description:

After receiving approval from the Executive Team, a proposal schedule is developed and tentative resources are assigned to the proposal development tasks. A list of qualified partners and suppliers is developed and non-disclosure agreements and teaming agreements are signed and attached to the opportunity in the system. Win themes and capture plans are updated based on the collaboration of partners and their roles in the system. Project management standards are developed and overall project management plans including communications plans, risk management plans and status reporting processes are established. A draft proposal is submitted for review along with the revised proposal budget and other associated documents before proceeding to the next step of the acquisition process.

Benefits:

Visible Process: BAMS tool 28 may provide visibility into the progress of specific opportunity through the use of preconfigured status fields. BAMS tool 28 may also provide the overall view of all the opportunities and their progress within the enterprise.
Collaboration: BAMS tool 28 may provide the ability to share the proposal schedule and tasks assigned to individual proposal team members. This may provide enhanced visibility into the proposal schedule. Further, through the use of a role-based portal, authorized team members and organizations (internal or external), can collaborate on teaming agreements.
System Integration: BAMS tool 28 may provide the capability to import the proposal schedule developed in an external project management application and to assign resources and material from the back-end systems. This ensures that the schedule is stored in a central location and at the same time uses the scheduling features of the external project management application. This also makes sure the resource data and commitments are consistent across the systems.
Storage and Reporting: BAMS tool 28 may provide ability to store all documents related to the pursuit planning process at one central location with the ability to review win/loss rates with partnering organizations. BAMS tool 28 may create records of reworked and dropped opportunities to aid in identifying possible issues with quality, justification or viability of a mature opportunity.
   Benefits by Role:
Capture Manager: BAMS tool 28 may allow the Capture Manager to identify capabilities required for the project and partners needed to satisfy those capabilities. The capabilities and partner information is retrieved from the back-end systems reducing the redundant data entry and ensuring the consistency of data across the systems. BAMS tool 28 may allow the Capture Manager to store the opportunity related data such as Win Theme and Capture Plan, NDA and Teaming Agreements to a single repository.
Proposal Manager: BAMS tool 28 may allow the proposal manager to develop the proposal schedule in a widely used project management applications such as MS Project, and to assign resources from the back-end HR system to the proposal tasks. This ensures the proposal schedule is resource loaded only with resources that are available and qualified. The proposal schedule and task assignment are visible to all authorized members of the proposal development team. BAMS tool 28 may allow the Proposal Manager to store the project management documents such as communication plan, risk management plan, status reporting process, and project management standards to a single repository.
Executive: BAMS tool 28 may provide a single source to review the opportunity data and related documents. The portal based architecture allows executives to access the system and view other executive decisions creating an executive peer review and collaboration environment. Decisions to pursue opportunities are permanently stored with each opportunity to document executive level approvals or decisions to not pursue.
   Solicitation Planning
   Process Description:

Upon receipt of an RFP, the proposal development project plan along with resource assignments are updated to reflect the RFP's scope of work. A collaborative environment is established where partners and suppliers can work together as an integrated proposal team. The scope of the RFP is reviewed and an initial compliance matrix is developed to track requirements and adherence to RFP requirements. Amendments to the RFP and answers to questions are recorded and generic proposal material is developed. After developing a detailed understanding of the RFP, a review is conducted to validate the decision to bid. In certain embodiments, detailed proposal development tasks begin only after executive approval.

Benefits:

Visible Process: BAMS tool 28 may provide visibility into the progress of specific opportunity and the follow on relationship to any RFPS, RFQs, and RFIs stemming from the opportunity. BAMS tool 28 may provide an overall view of all the opportunities follow on RFx and their progress within the organization.
Collaboration: Collaborative environment allows team members including partners and suppliers to work in a work environment where they can share files and collaborate on work products within the confines of their assigned roles.
System Integration: Resource allocation is updated in the back-end system. This ensures that qualified and available resources are assigned to the appropriate proposal tasks.
Storage and Reporting: BAMS tool 28 may provide the ability to keep all the documentation related to the RFP in one central location. This central data storage helps with retrieving proposal information common across proposals as well as information needed for the compliance matrix.
   Benefits by Role:
Capture Manager: The Capture Manager can review the decision of the Executives and make the final decision regarding the proposal preparation. The Capture Manager also benefits by viewing the compliance matrix to determine if requirements specified in the RFP align with existing capabilities and qualifications.
Proposal Manager: BAMS tool 28 may allow the Proposal Manager to store the RFx related documents such as the RFP, amendment(s), and questions and answers in a single repository. This may ensure that all the important procurement related documents are available in the same system. The Proposal Manager further benefits from the development of the compliance matrix to determine if the proposal team members can deliver a solution to meet the requirements or if additional resources or external capabilities are required.
Proposal Team Member: Team member can collaborate with other team members in a single system. The defined and repeatable business acquisition process ensures that all team members are aware of the acquisition process, their roles, tasks, and responsibilities. The proposal team members can also store and track the progress of the compliance line items. This provides visibility and single system for storage of compliance requirements.
Executive: During the solicitation planning process, executives review and approve another critical milestone, the validation to continue with detailed proposal development. The portal based architecture allows executives to access the system and view other executive decisions creating an executive peer review and collaborative environment. The validation to continue with proposal development is permanently stored with each RFP to document executive level approvals to continue with the bid process.
   Proposal Development
   Process Description:

The proposal development business process includes sending letters of intent to the customer, preparing proposal content including technical and financial approaches, collecting certifications as needed for the compliance matrix, and preparing for orals. The WBS for executing the government's proposal is referred to the execution schedule. The execution schedule is developed during the proposal development process including identifying resources (positions) and material needed to execute the project. The labor positions, material, and tasks form the basis the proposal pricing. Proposal pricing is done external of BAMS tool 28. Peer, financial, legal and executive approvals to submit the proposal and bid are conducted to conclude the proposal development process.

Benefits:

Visible Process: BAMS tool 28 may provide visibility of multiple aspects of the proposal development process. The proposal includes controlled folders for containing technical and financial approaches, an execution schedule loaded with resources and materials, and status of the proposal. BAMS tool 28 may also provides a collective view of all proposals, their relationships to each RFx, and preceding opportunity(ies) and status within the organization.

Decisions are documented; information from the back-end systems are brought forward and all documentation is visible in the system.
Collaboration: BAMS tool 28 may provide a collaborative environment for proposal team members including partners and suppliers to develop the proposal contents, WBS, schedule and pricing model inputs. The use of portal based roles and knowledge management folders organize the proposal development space to authorize access to information based on roles.
System Integration: The execution schedule can be developed using any of the supported external project management application and can be imported into BAMS tool 28 for resource assignment from the back-end human resources system. This provides ability to use the best of breed systems and still use BAMS tool 28 to collaborate and share the execution schedule with all the team members.
Storage and Reporting: BAMS tool 28 may provide common repository to store proposal contents, status, and supporting information (e.g., bid price) to be used for win/loss analysis and potentially for future proposals. A common repository also provides search capability that can be used to retrieve past proposal documents quickly.
   Benefits by Role:
Capture Manager: The single source of document storage allows the Capture Manager to compile the proposal content and review documents from various team members. The Capture Manager always has access to the most recent version of the document.
Proposal Manager: The Proposal Manager can store all the proposal content including documents, bids, and drawings inside BAMS tool 28 and collaborate with partners/vendors on various contractual issues.
Proposal Team Member: BAMS tool 28 may provide a repository that allows the team members to search past proposals and documents within authorization limits. This can significantly reduce the time spent in searching and re-writing the proposal content. The proposal team member can also develop an execution schedule with widely used project management applications such as MICROSOFT PROJECT. The team members can import the schedule into BAMS tool 28 and assign resource positions, personnel and labor rates from the back-end HR system, and material from the back-end material management system. It is also possible to assign partner resources and materials. This maintains a single system of record for resources and materials in the back-end while BAMS tool 28 may use this same information for proposal development. The Team Members working on the proposal content can use the collaborative environment to store and share documents with the partners/vendors.
Partner/Vendor: The partners/vendors can collaborate on the proposal content with the proposal team members. The proposal team can control the access provided to the partner/vendor team members. This ensures secured and collaborative environment for all the proposal team members to work together.
Executive: BAMS tool 28 may extend the approval process prior to submitting the process to executives and other review teams (peers, financial analysts, quality assurance, and legal). BAMS tool 28 may maintain records of the approval processes documenting what, when, and who made the approvals for submission. Executives can also later view awarded or lost proposals to evaluate bid and proposal budgets vs. actual for follow-on analysis.
   Contract Negotiation
   Process Description:

This business process starts with conducting orals, answering client's follow-up questions, award of the contract or notification of non-award, and conducting lessons learned sessions. After negotiation, the proposal may be re-worked with changes to teaming agreements, execution schedule, pricing, and scope of work. A Statement of Work (SOW) is finalized, and the final terms and conditions of the contract are agreed upon and signed. A win review is conducted and a project kick-off meeting is scheduled. If the customer declines the revised offer or the contract is not awarded, a loss review is conducted. The BAMS business process concludes with win-loss review and internal lessons learned sessions. In the case of a win, the execution schedule and compliance matrix form the basis and launching point for the transition team to develop the actual execution schedule, staffing plan, and requirements database.

Benefits:

Visible Process: BAMS tool 28 may provide visibility of the submitted proposal, rework/revision of the proposal during contract negotiation, and the final proposal which forms the basis of the contract award. BAMS tool. 28 may provide a collective view of all proposals, their status of development, and resulting win or loss. The end-to-end process from opportunity capture to negotiated proposal is contained in BAMS tool 28. Further, supporting documents and decisions at each point in the acquisition management process are contained in BAMS tool 28. All past objects, attached documents, and decisions are accessible via authorized access.
Collaboration: The collaboration capability during the contract negotiation phase provides a work environment for the proposal team members, quality assurance team, legal team and external partners and suppliers to revise and maintain version control of the changes to the proposal and supporting SOW.
System Integration: BAMS tool 28 may provide integration with external project management systems during the contract negotiation, SOW development, and transition activities to eliminate or reduce the need to re-create an execution schedule, staffing plan, budget, and requirements database post contract award. This significantly improves the efficiency of the handoff from the sales/proposal team to the production team. It should also increase visibility between the proposed and actual bid and proposal costs, providing more accurate bid and proposal estimates in the process.
Storage and Reporting: The proposal win and loss reviews are stored in the central BAMS repository (e.g., database 18). The lessons learned database becomes an integral part of the organization's knowledge base to be used in future proposals.
   Benefits by Role:
Capture Manager: BAMS tool 28 may allow the Capture Manager to store the orals and contract negotiation related information in a single repository. The lessons learned document becomes a knowledge product that can be used to improve the acquisition process and conduct more extensive win/loss analysis for future opportunities.
Proposal Manager: The Proposal Manager can conduct the execution hand over by converting the high level execution schedule developed during the proposal development phase into the format used by the project management system used during the execution phase. The MICROSOFT PROJECT schedule can be converted to many different commercially available project management systems such as SAP PROJECT SYSTEMS and PRIMAVERA.
Proposal Team Member: The team members can retrieve and revise the proposal documents based on changes required as a result of contract negotiations.

FIG. 2 illustrates an example process for managing business acquisitions, according to certain embodiments of the present invention. The steps described with reference to FIG. 2 provide example basic steps for managing business acquisitions. The method illustrated in FIG. 2 may be implemented using BAMS tool 28, which may provide a user interface 30 (including a plurality of GUI screens) to user system 12.

Steps 200 through 206 may be sub-processes of the Capture Opportunity process. At step 200, a Capture Opportunity process may be performed. The Capture Opportunity process may include facilitating the establishment and approval of a business opportunity. As just a few examples, the business opportunity could be originate from a request for information (RFI), request for proposal (RFP), request for quote (RFQ), or other suitable inquiry from a potential or existing client of an enterprise.

This process may involve creating the opportunity and assigning roles to the opportunity. The Business Manager creates the opportunity, typically with reference to a lead. The opportunity is created with reference to a customer, which is pulled from the customer records in the enterprise's ERP system. Upon creation of the opportunity, the Business Manager assigns the Proposal Manager and/or Capture Manager and routes the opportunity accordingly. The availability of Capture Manager and Proposal Manager are updated in the back-end human resources system to reflect the assignment. At this point, the opportunity has been first created and the assigned to the Managers who will pursue the opportunity.

At step 202, a Develop Opportunity process may be performed. This process involves establishing a bid-and-proposal high-level budget, developing the business case, developing a win themes/capture strategy, and identifying the capabilities required to pursue and fulfill the opportunity. These functions man take place concurrently. Capabilities that cannot be fulfilled with internal resources are usually partnered/subcontracted to other enterprises. At this point, the bid-and-proposal budget may be an early estimate, allocated at the line item level for personnel, material, and other costs, and may be rolled up to the header level. All three of the documents may be revisited and refined as the opportunity is further developed.

At step 204, a Decide on Pursuit Planning Package process may be performed. This process may involve assigning Executives to the opportunity, routing the opportunity for review, collecting Executive feedback, and making an executive decisions on the status of the opportunity. The assigned Executives may receive a system-generated (e.g., by BAMS tool 28) communication (e.g., an e-mail, page, text message, or voicemail) and links to the opportunity object to be able to review the opportunity, the preliminary budget, proposed teaming, and win themes/capture strategy. Dropping the opportunity at this stage minimizes the effort and expense of chasing opportunities that are outside the goals of the enterprise or have a low chance of working.

Steps 206 through 214 may be sub-processes of the Pursuit Planning process. At step 206, a Create Project Standards process may be performed. This process involves establishing standards and procedures for the project/proposal. This includes establishing a communication plan, status reporting process, and a risk management plan. The standards may be used to guide the proposal process. The documents may be attached to the opportunity object in BAMS.

At step 208, a Create Proposal Schedule process may be performed. The proposal schedule may be developed by the Proposal Manager using a project management application (e.g., a backend service 24). The proposal schedule may include work breakdown structure (WBS) elements, activities, relationships, schedule dates for activities, and other suitable information. The proposal schedule may be imported to BAMS tool 28 from project management application, such as MICROSOFT PROJECT. The team members may be able to view the WBS elements, activities, and schedule dates for the proposal schedule in BAMS based on the team member's authorization profile. Resources and materials can be assigned to the schedule from back-end services 24 (e.g., human resources system 24a and a material system). The resources from partner companies can be added and assigned in BAMS. The resource-loaded schedule can be exported back to the original project management application. The project management application (e.g., project system 24c) may be used to update the schedule information, such as activities, duration, and relationships. The updated schedule is imported to BAMS tool 28. The project management application may be MICROSOFT PROJECT, SAP PROJECT SYSTEMS, PRIMAVERA, ARTIMUS, or any other suitable project management application.

At step 210, a Create Teaming process may be performed. This process involves selecting qualified partners and suppliers, establishing one or more nondisclosure agreements and one or more teaming agreements for each partner and preferred supplier. The win themes/capture strategy may be updated. This update may also occur if a rework is ordered during the Decide to Pursue process. Each of the documents is attached to the opportunity object of BAMS tool 28 At step 212, a Create Bid-And-Proposal Budget process may be performed. This process involves setting the bid-and-proposal budget, which relies on approving the one or more teaming agreements (external), assigning qualified resources (internal and external), and assigning materials and services needed during the proposal phase.

At step 214, it may be determined whether to pursue the proposal using a Decide to Pursue process. This process involves deciding on whether to continue to pursue or to drop the opportunity or rework and the decision-related steps. This is the second of many Executive reviews that are necessary to continue involvement at the right level of the company. At this point, the Executives can approve to pursue, disapprove with instructions to rework, or the drop the opportunity.

Steps 216 through 224 may be sub-processes of the Solicitation Planning process. At step 216, a Process RFx process may be performed. This process describes how to manage a received RFx. It includes acknowledging the receipt of the RFx to the customer and team, and entering the RFx information into BAMS tool 28.

At step 218 a Staff Proposal Team process may be performed. This may include either or both internal and external teams. Once the RFx is received from the customer, the required competencies (external and internal) needed to produce and fulfill the proposal for the engagement requirements may be identified. The resource assignments for the tasks are finalized in the proposal. The human resources system (e.g., human resources system 24a) may be updated to confirm the assignments for the resources and the project plan may be updated. For the external resources, the data may stored in the BAMS tool 28. A compliance matrix may be developed in BAMS tool 28 to help track the requirements specified. The collaboration environment specific to the proposal may be enabled for the proposal team. Access to various folders and the type of access may be controlled by assigned roles.

At step 220, a Define Proposal Scope process may be performed. Once the RFx is issued, the specific requirements and scope may be identified and/or enumerated. This information may be captured as line items in a compliance matrix. Some of the compliances may be pertinent to the partner/supplier, or to the enterprise itself. For each of these, a separate line item may be added to the compliance matrix.

At step 222, a Review and Refine RFx process may be performed. This process details the reviewing and refining of the RFx, if any. After the RFx is received by the enterprise, the RFx may undergo multiple reviews, and any questions that might arise in the review process may be submitted to the customer. The customer may issue amendments to the original RFx that may need additional clarification. The Review and Refine RFx process may be undergo multiple iterations until the proposal team feels that all of the questions have been addressed and/or the customer stops issuing amendments. A generic proposal content document may be developed and attached to the RFx object as a framework for the final proposal document.

At step 224, a Validate Decision to Bid process may be performed. After the RFx has been issued and the scope of the opportunity is defined, a third review with the Executives may be performed. At this point, the decision is either to continue to pursue the opportunity and develop the proposal or to drop the opportunity. Even though a team has been formed, complex or cost prohibitive proposal development may result in not continuing with the proposal development.

Steps 226 through 230 may be sub-processes of the Proposal Development process. At step 226, a Develop Proposal process may be performed. Once the decision to pursue the opportunity beyond the RFx process is made, a proposal object may be created by BAMS tool 28, along with a framework to capture all the relevant processes and documents and to help track completion. A letter of intent may be sent to the customer and a copy may be stored by BAMS tool 28 (e.g., in database 18). Roles and responsibilities may be finalized between team members, and contacts for each area are identified, within the enterprise and across the partner organizations. A tracking process may be put in place to ensure all the required compliances are fulfilled and the compliance matrix is updated with status. The terms and conditions are reviewed and finalized during the proposal development phase. The proposal team ensures that the key win themes/capture strategy are incorporated in the final proposal. Key subcontractors may be monitored to ensure that they fulfill contractual compliance. The execution WBS and schedule provide input to an external pricing engine. As this process is completed, the proposal team may compile the content for further reviews by appropriate entities (e.g., peer review teams, financial review teams, legal organizations, and executives).

At step 228, an Establish Execution Schedule and Pricing (External) process may be performed. This business process includes establishing an execution schedule, assignment of material and resources, cost modeling, and developing pricing for the execution of the proposal. BAMS tool 28 may initiate display of the final execution schedule, and the cost, material, and resources assigned to the execution schedule. The pricing model is external to the BAMS tool 28; however, the final submitted bid is contained on the proposal object for documentation purposes. Access to this information is controlled through the use of portal based roles.

The Establish Execution Schedule and Pricing (External) process may include one or more of the following functions.
Establish BOMs, Routings, Other Specs—In this business function, RFx document is reviewed for design guidelines and material specifications. Based on the requirements identified for the design and material components, Bill of Materials (BOMs) are established in the material management system. BOMs include hierarchy of material components needed to build a formal assembly of components.
Establish execution schedule—This business function involves development of execution schedule. The execution schedule includes WBS elements, activities, and relationships to define the schedule of activities needed for execution of project. This schedule becomes part of the execution schedule submitted to the client. This is developed in project management application such as SAP's PROJECT SYSTEMS, PRIMAVERA, and MICROSOFT PROJECT.
Import execution schedule in BAMS tool 28—After the development of execution schedule in project management application, user imports the execution schedule from the external Project Management System. Team members are able to view the WBS Elements, activities and scheduled dates for the execution schedule in BAMS tool 28 based on their authorization profile.
Define Execution positions—This business process includes identifying the resources needed to execute the project. Resources are quantified (5000 labor hours of welders) by position rather than identified (actual person). Quantified resources are assigned to the execution schedule activities to ensure that the required resources are available.
Assign Material Components—This includes assigning material components to the execution activities. Material components are assigned from the back-end legacy system.
Assign Material and Resources positions provided by partners—Material components and resources provided by business partners for the execution of project are stored in BAMS tool 28 and Proposal Manager assigned them to proposal activities on a needed basis.
Populate and Execute Cost Models—This business function includes populating cost models based on the quantified resource, material, equipment, and subcontractor costs. Project pricing is developed based on the cost model and contract terms and conditions. This activity is performed using an external pricing engine and is implemented in the external cost modeling and estimating application.
Review Cost, Schedule and Resource Variables—This business function involves review of schedule, cost, and resource availability to make sure execution plan satisfies the requirement listed in the RFx as well as internal resource availability. Execution schedule and cost model is revised to make sure proposed schedule and price satisfies the client's requirements.
Export resource loaded schedule to project management application—After the assignment of resources and material, the resource loaded Project Schedule is exported back into the project management application. Project management application is used to make any changes to the Project Schedule. After schedule change, Project Schedule is imported back into the BAMS tool 28.

At step 230, a Submit Proposal process may be performed. This process involves the development of the proposal cover letter, the completion of the compliance matrix, and the review of the proposal prior to submission of the proposal. In certain embodiments, the Capture Manager develops the cover letter and the Proposal Manager completes the compliance matrix. When the cover letter and compliance matrix are complete, the Review Team may review and clear them for any issues before submission to the customer.

Steps 232 through 236 may be sub-processes of the Contract Negotiation process. At step 232, a Conduct Oral Review process may be performed. This process involves presenting the proposed solution and addressing the key concerns of the customer. For example, the proposed solution may be present in a MICROSOFT POWERPOINT presentation. The purpose of the oral review is to conduct a face-to-face discussion that reinforces the enterprise's understanding of the requirements and proposed solution. Questions and answers may clarify any misunderstanding of the requirements or the proposed solution for the customer. The proposal object generated by BAMS tool 28 may provide a connection point for storage of the final orals documentation.

At step 234, a Revise/Rework Proposal process may be performed. In this scenario, the customer has selected the enterprise for the proposed worked. Contract negotiations begin, and the tasks of developing or refining the statement of work begins. The negotiation can result in a need to rework/revisit the proposal content (e.g., to address a change in scope, costs, teaming agreement, or project schedule). The final documentation may support a statement of work to be agreed on by both parties.

At step 236, a Close out Contract process may be performed. This process involves the activities that take place after the contract is won or lost. This includes a win/loss review and if won, a kickoff meeting and project handover.

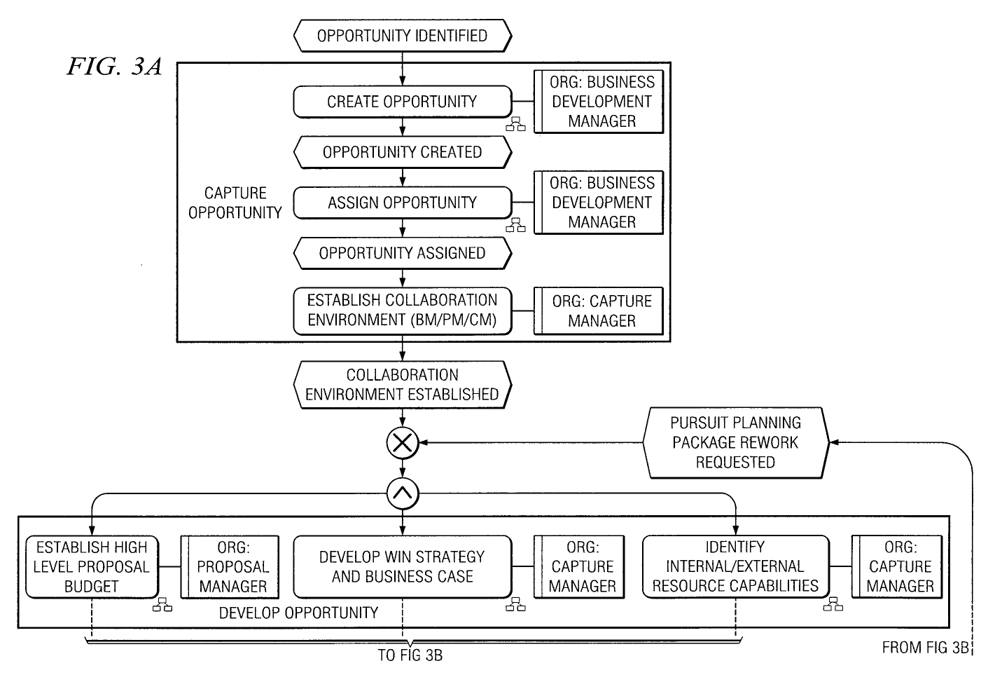

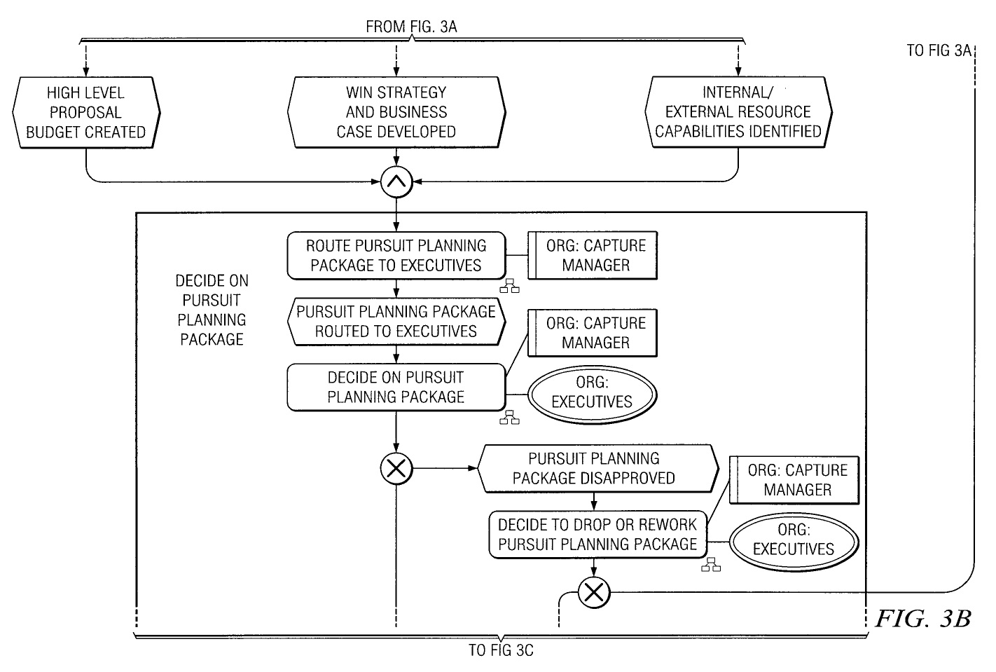

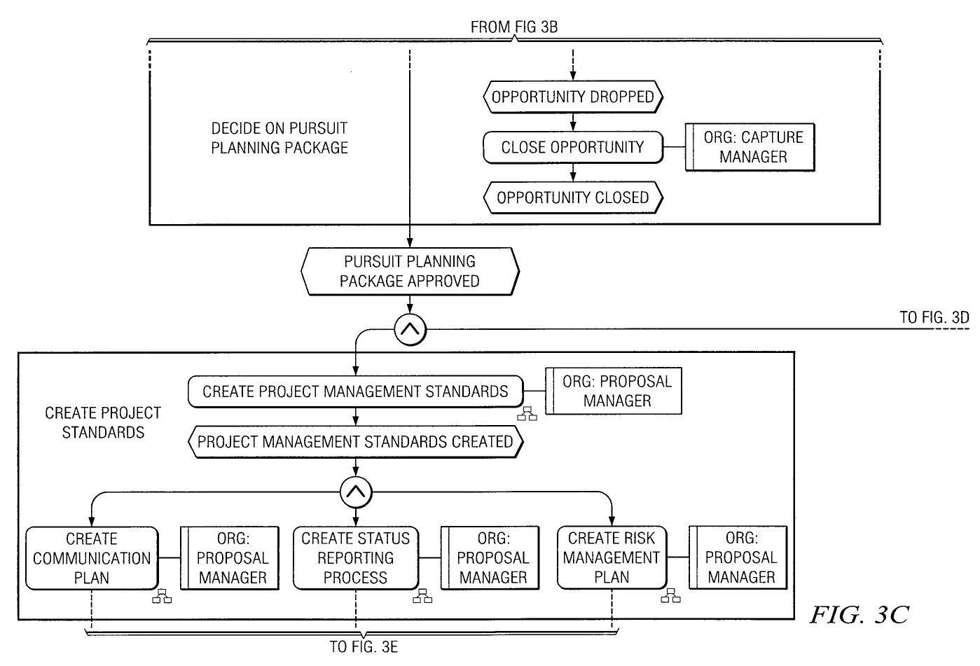

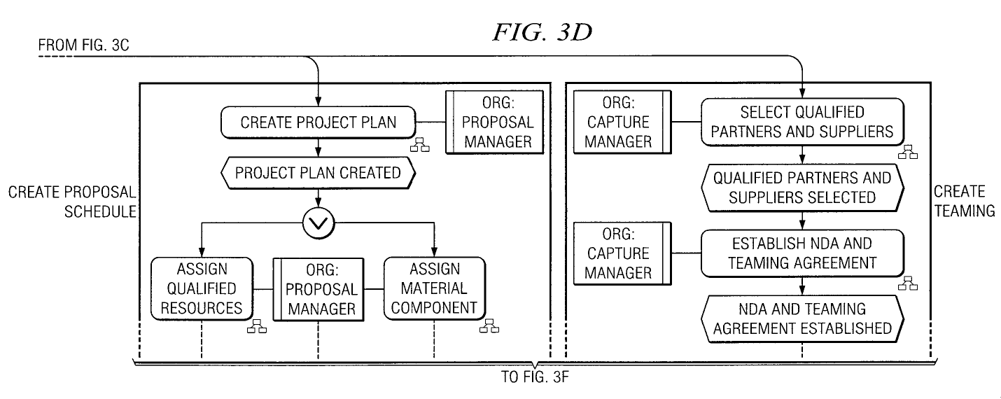

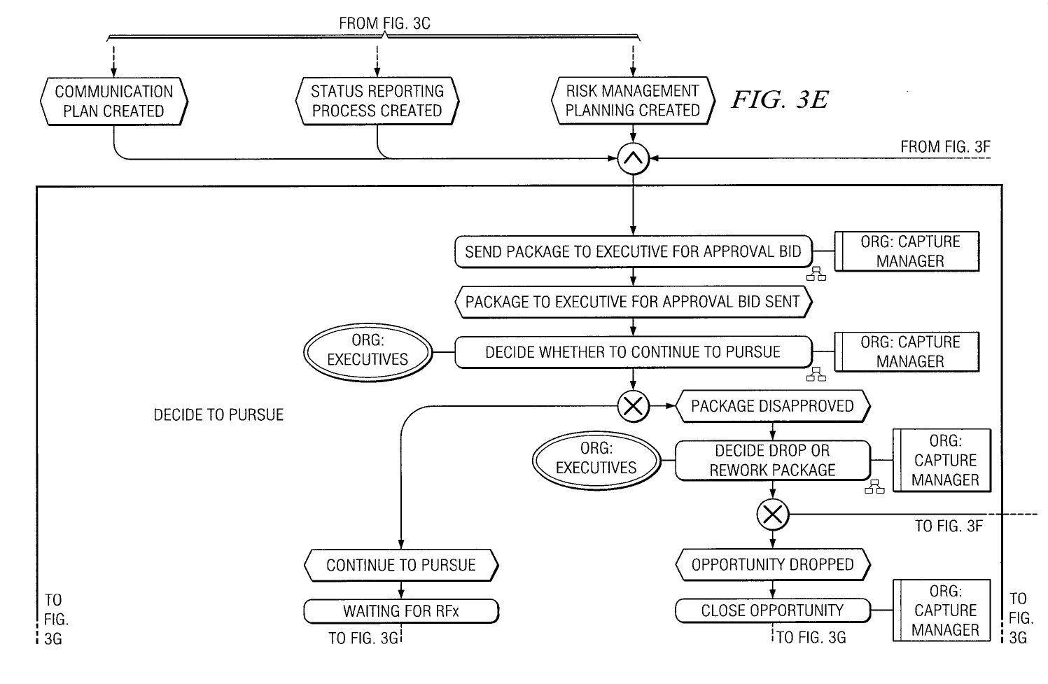

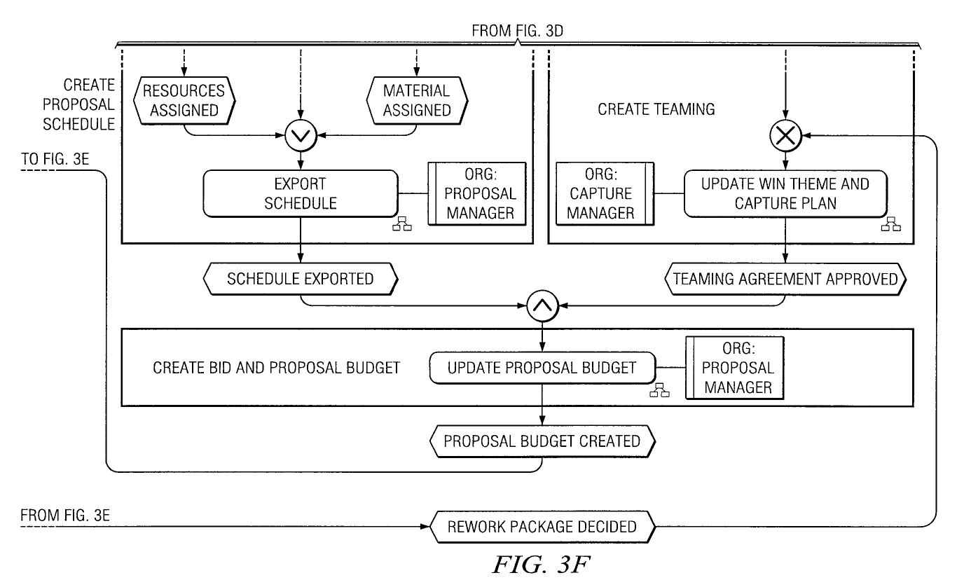

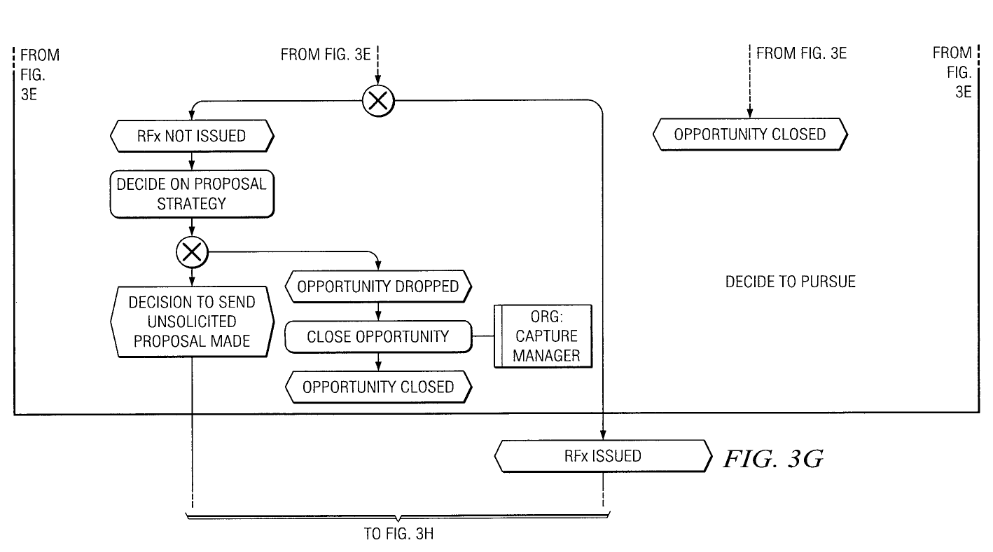

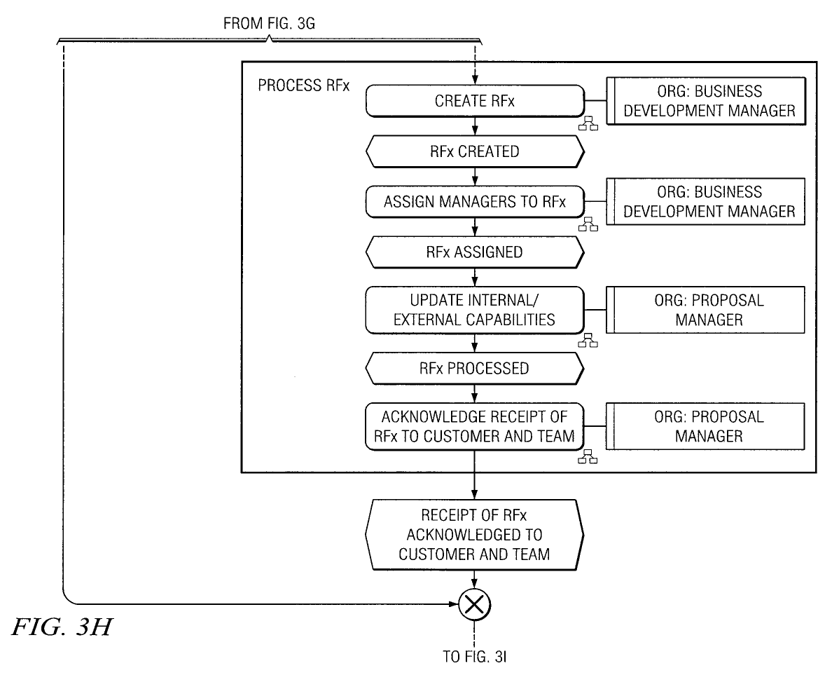

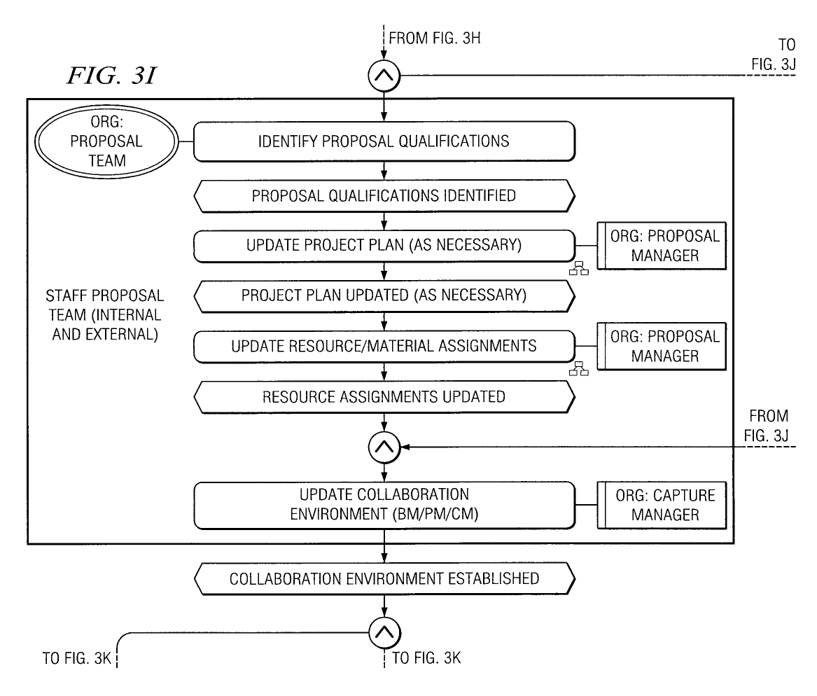

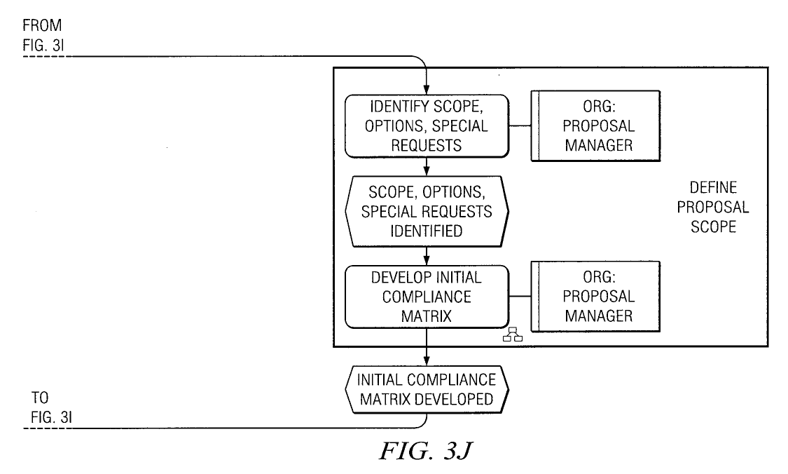

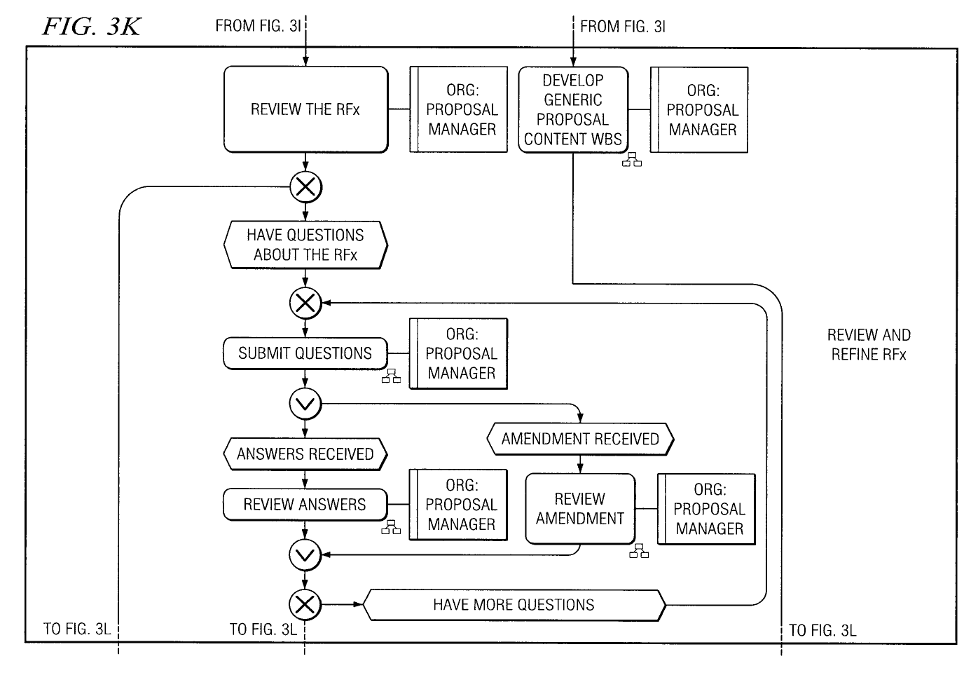

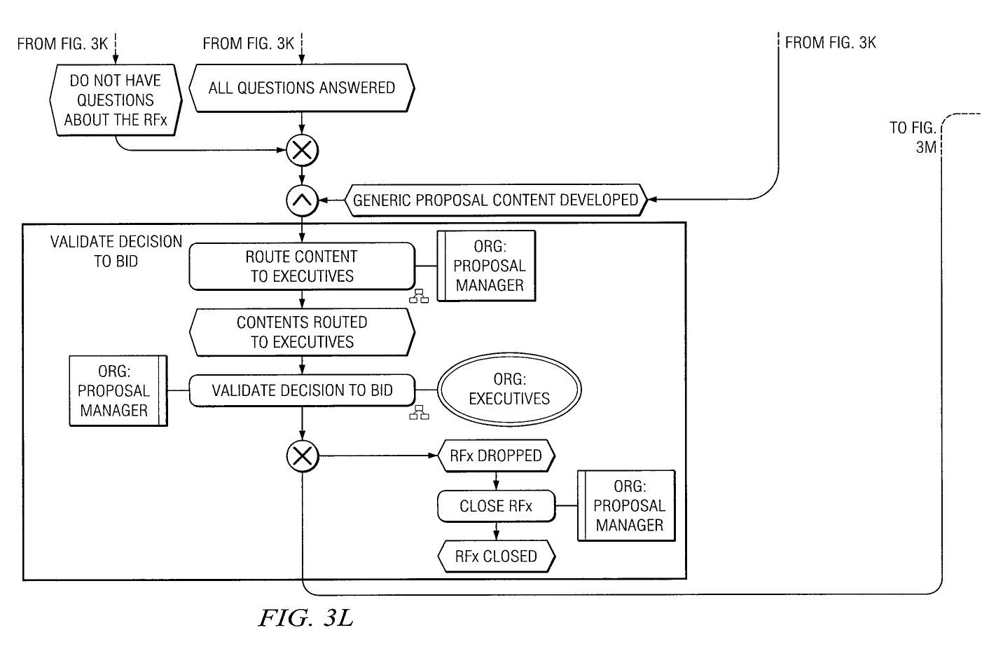

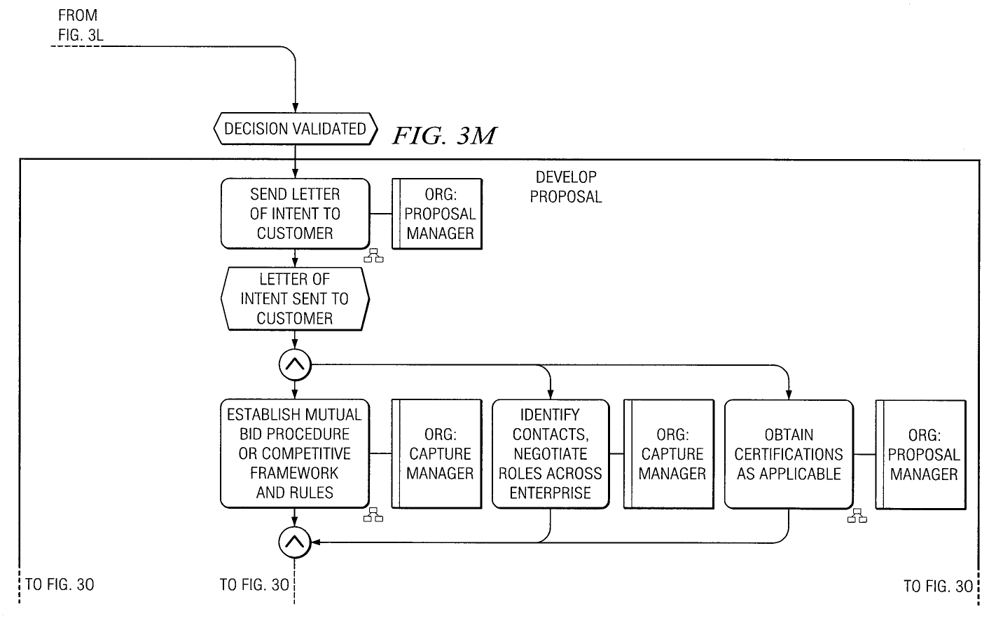

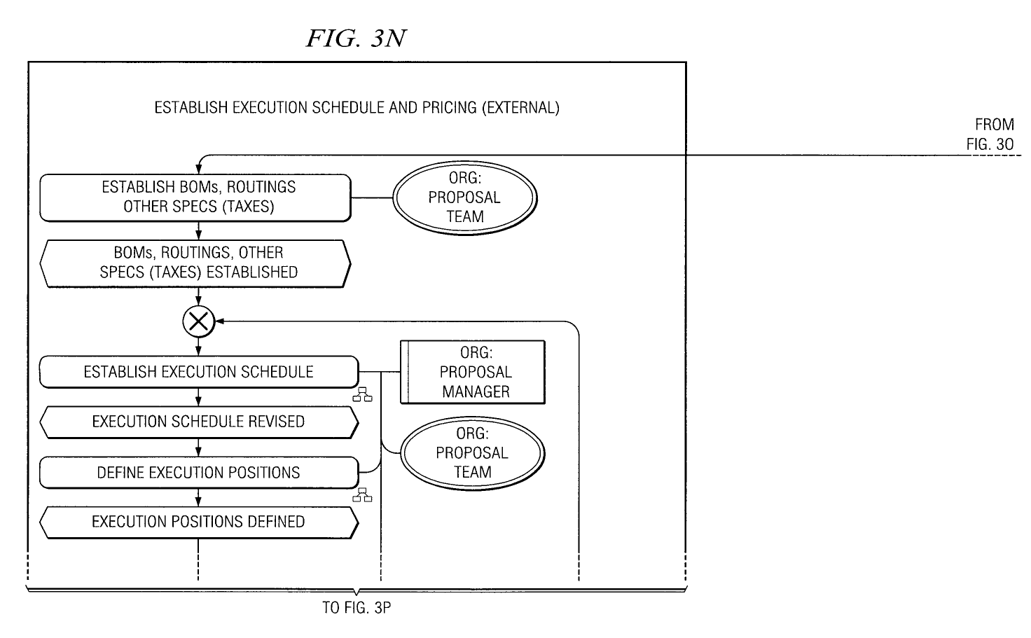

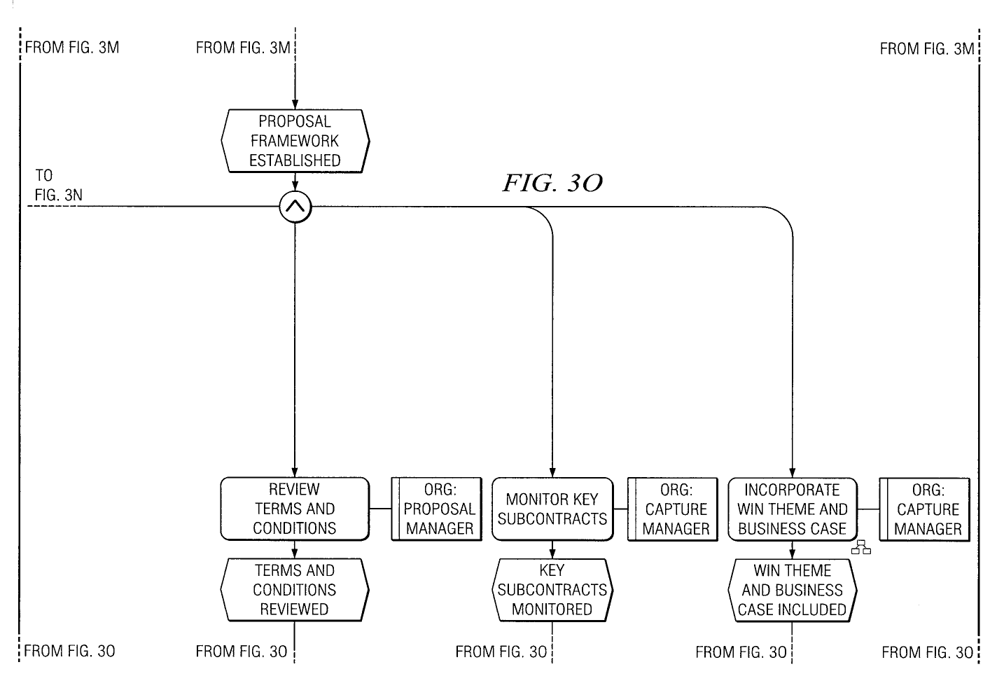

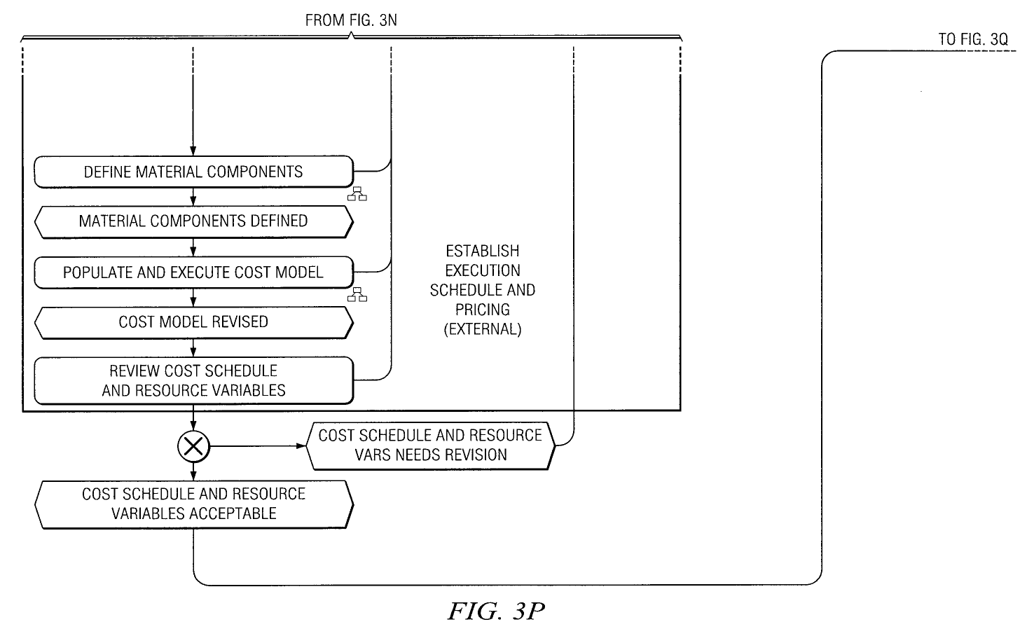

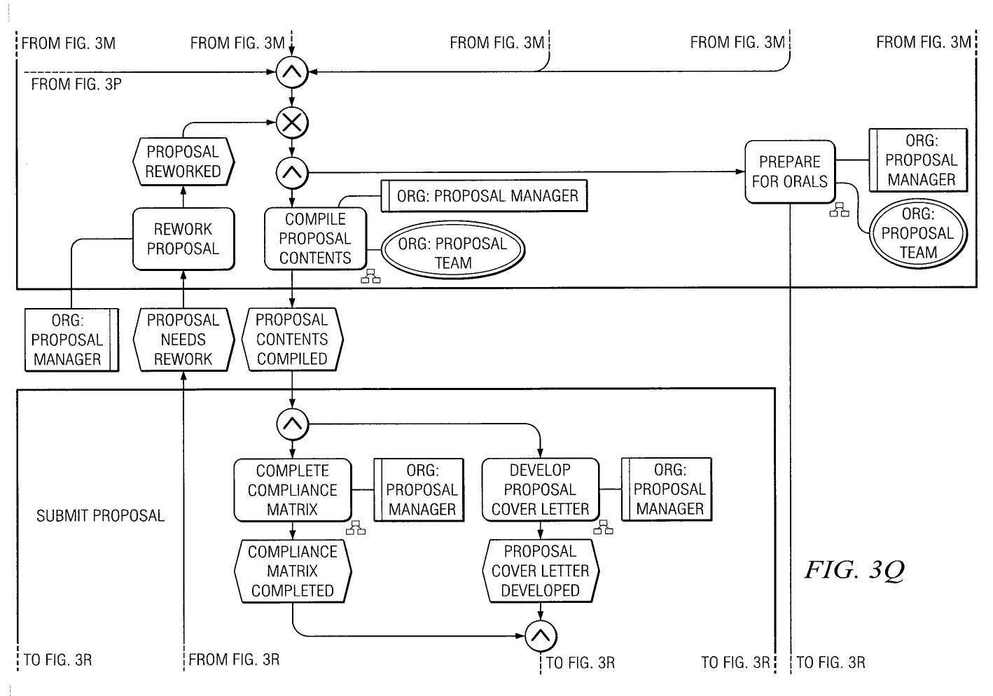

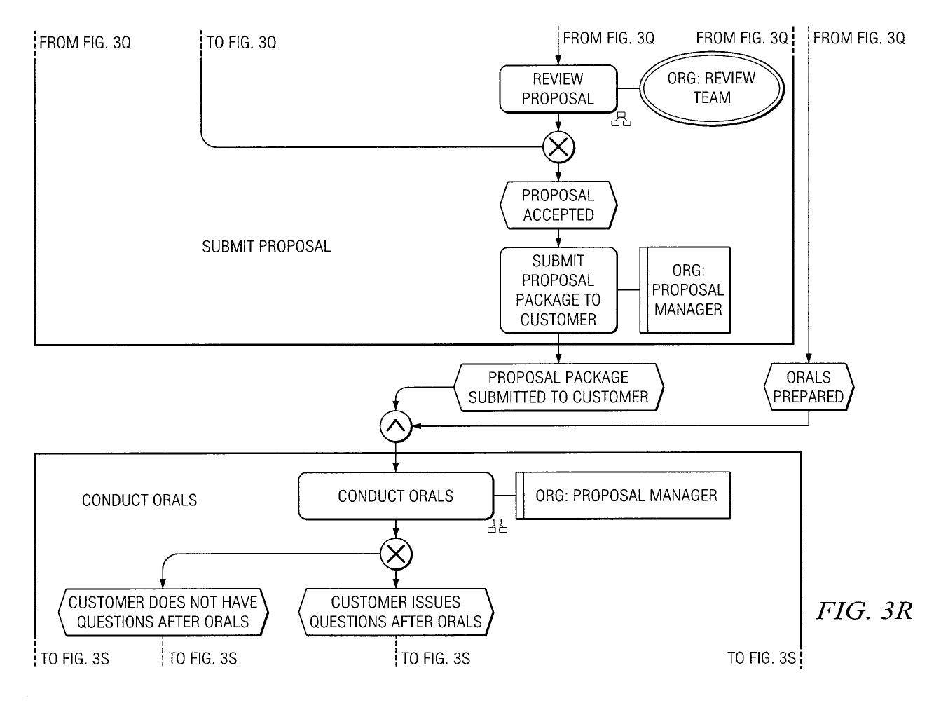

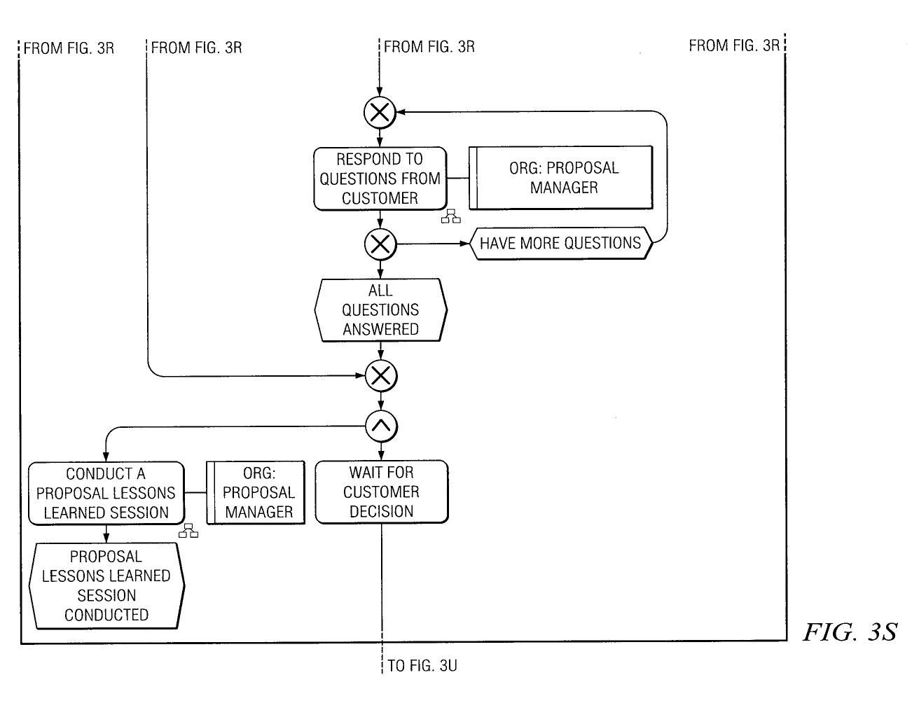

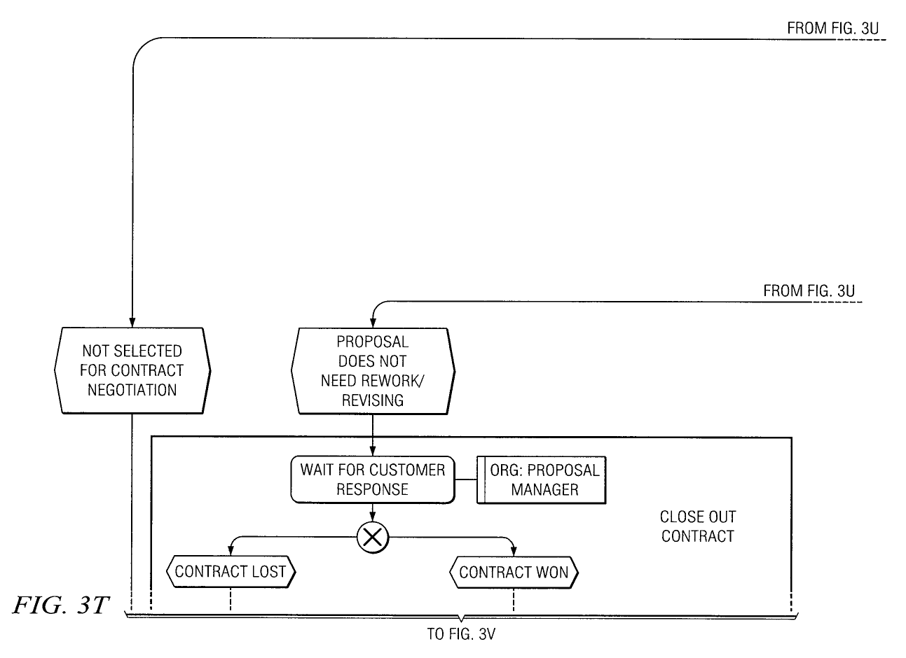

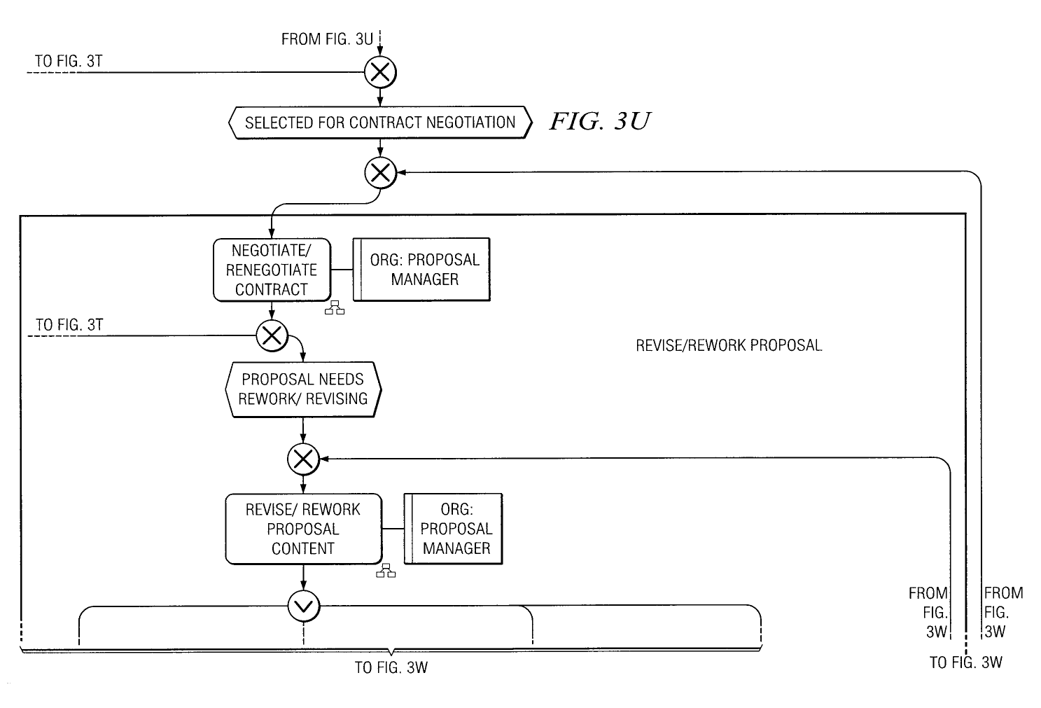

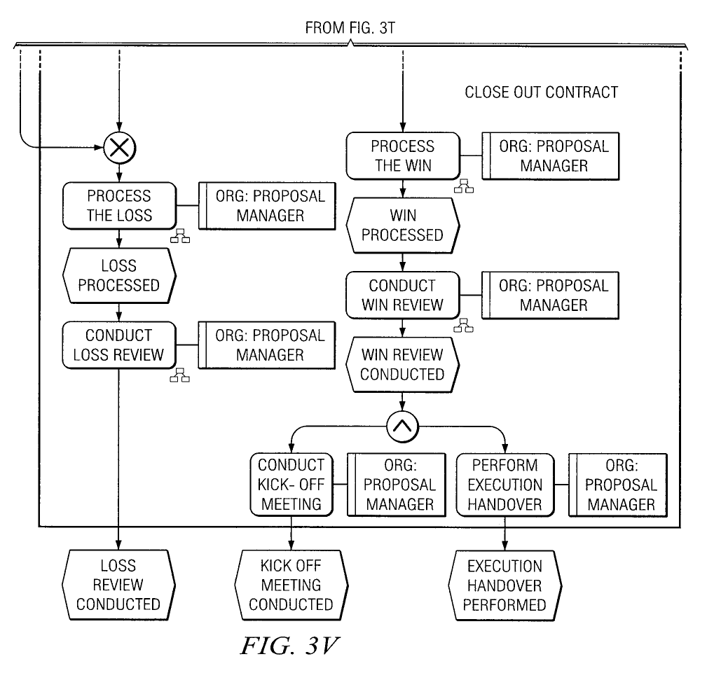

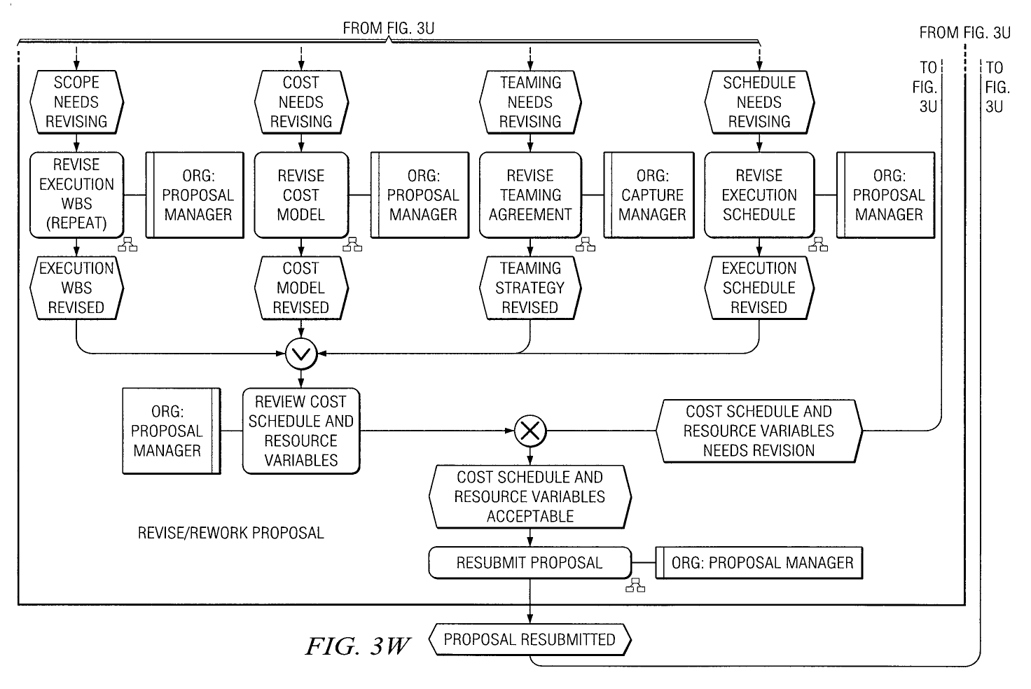

FIGS. 3A-3F illustrates a more detailed example process for managing business acquisitions, according to certain embodiments of the present invention. The flowchart shown in FIGS. 3A-3F includes example details for each of the steps of the example method illustrated in FIG. 2.

A Capture Opportunity process may include Create Opportunity and Assign Opportunity sub-processes. The Create Opportunity sub-process may include searching for the associated customer in backend services 24, creating an instance of the opportunity, and updating the opportunity status. The Assign Opportunity sub-process may include searching for an appropriate Proposal Manager and/or Capture Manager, assigning the Proposal Manager/Capture Manager to the opportunity, assigning dates and updating availability of the Proposal Manager/Capture Manager, automatically notifying the Proposal Manager/Capture Manager, and updating the opportunity status.

A Develop Opportunity process may include a Develop Win Strategy and Business Case sub-process, an Identify Internal/External Resource Capabilities sub-process, and an Establish High-Level Proposal Budget sub-process. The Develop Win Strategy and Business Case sub-process may include drafting one or more documents establishing the win strategy and business case, attaching those documents to the opportunity in BAMS. BAMS tool 28 may automatically update the opportunity status. The Identify Internal/External Resource Capabilities sub-process may include retrieving capabilities (e.g., from backend services 24), searching for internal capabilities (i.e., within the enterprise that is preparing the proposal), assigning internal capabilities, searching for external capabilities, and assigning vendors to external capabilities. BAMS tool 28 may automatically update the opportunity status. The Establish High-Level Proposal Budget sub-process may include setting the budget for the opportunity. BAMS tool 28 may automatically update the opportunity status.

A Decide on Pursuit Planning Package process may include a Route Pursuit Planning Package to Executives sub-process, Decide on Pursuit Planning sub-process, and, if appropriate, a Decide to Drop or Rework Pursuit Planning Package sub-process. The Route Pursuit Planning Package to Executives sub-process may include searching for Executives (e.g., using backend services 24), selecting and assigning executives to the opportunity, and communicating a notification of the opportunity and required tasks to the selected Executives. BAMS tool 28 may automatically update the opportunity status. The Decide on Pursuit Planning sub-process may include entering/saving decision (regarding whether to purse the opportunity) and comments. BAMS tool 28 may automatically update the opportunity status. The outcome of this sub-process may be that the pursuit planning package is approved or disapproved. The Decide to Drop or Rework Pursuit Planning Package sub-process may include entering/saving the decision and comments. BAMS tool 28 may automatically update the opportunity status. This sub-process may be performed if the pursuit planning package was disapproved. The outcome of this sub-process may be that the opportunity is dropped or that a pursuit planning package rework is requested.

A Create Project Standards process may include a Generate Project Management Standards process, a Create Risk Management Plan process, a Create Communications Plan process, and a Create Status Reporting process. Each of these processes may include attaching relevant documents to the opportunity object.

A Create Proposal Schedule process may include a Create Project Plan sub-process, an Assign Qualified Resources sub-process, an Assign Material Component sub-process, and an Export Schedule sub-process. The Create Project Plan sub-process may include retrieving skills from backend systems 24, searching for qualified resources based on skills, and assigning resources to proposal schedule activities. The Assign Qualified Resources process may include retrieving skills from backend systems 24, searching for qualified resources based on skills, and assigning resources to proposal schedule activities. The Assign Material Component process may include searching for material and assigning material. The Export Schedule process may include exporting the schedule to the project management application (e.g., project management system 24c).

A Create Teaming process may include a Select Qualified Partners and Suppliers process, an Establish NDA Teaming Agreement process, and an Update Win Theme and Capture Plan process. The Select Qualified Partners and Suppliers process may include retrieving capabilities, searching for internal capabilities, assigning internal capabilities, searching for external capabilities, and assigning vendors to external capabilities. The Establish NDA Teaming Agreement process may include attaching relevant documents to the opportunity object. The Update Win Theme and Capture Plan process may include attaching relevant documents to the opportunity object.

A Create Bid-And-Proposal Budget process may include updating the proposal budget, which may include updating the budget for the opportunity.

A Decide to Pursue process may include a Send Package to Execute for Approval Bid sub-process, a Decide Whether to Continue to Pursue sub-process, a Waiting for RFx sub-process, and a Decide on Proposed Strategy sub-process, and a Decide to Drop or Rework Package sub-process. The Send Package to Execute for Approval Bid sub-process may include searching one or more backend systems 24 for Executives, modifying an executive list, sending a notification to selected executives, and updating the status of the opportunity. The Decide Whether to Pursue sub-process may include entering and saving the decision and any comments and updating the status of the opportunity. The Decide to Drop or Rework the Package sub-process may include entering and saving the decision and any comments and updating the status of the opportunity.

A Process RFx process may include a Create RFx sub-process, an Assign Managers to RFx sub-process, an Update Internal/External Capabilities sub-process, and an Acknowledge Receipt of RFx to Customer and Team sub-process. The Create RFx sub-process may include searching for the opportunity object for the opportunity associated with the RFx (e.g., in database 18), creating an RFx object, and copying opportunity-related information. The Assign Managers to RFx sub-process may include assigning a Proposal Manager/Capture Manager to the RFx, assigning dates and updating availability of the Proposal Manager and Capture Manager, notifying the Proposal Manager/Capture Manager, and updating the status of the RFx. The Update Internal/External Capabilities sub-process may include copying external capabilities/vendors from the opportunity object, updating the external capabilities/vendors, copying internal capabilities from the opportunity object, and updating the internal capabilities. The Acknowledge Receipt of RFx to Customer and Team sub-process may include attaching one or more documents to the RFx object.

A Staff Proposal Team process may include a Notify Proposal Qualifications sub-process, and an Update Project Plan sub-process. The Notify Proposal Qualifications sub-process may include creating a proposal schedule in project management service 24c and importing the proposal schedule into BAMS tool 28. The Update Project Plan sub-process may include retrieving skills from backend systems 24, searching for qualified resources based on skills, assigning resources to proposal schedule activities, and exporting the proposal schedule to project management service 24c.

A Define Proposal Scope process may include identifying the scope, options, and special requirements, as well as developing an initial compliance matrix. Developing the initial compliance matrix may include adding, based on the identified scope, options, and special requirements, compliance matrix line items.

A Review and Refine RFx process may include developing generic proposal content WBS. Alternatively, the Review and Refine RFx process may include reviewing the RFx, submitting questions, reviewing questions, and reviewing amendments (if appropriate). Each of these actions may include attaching appropriate documents to the RFx object.

A Validate Decision to Bid process may include routing appropriate content to Executives, validating the decision to bid, and either dropping and closing the RFx or approving the decision to bid. Routing the content to the Executives may include searching for Executives, modifying the Executives list, sending a notification to selected Executives, and updating the status of the RFx in the RFx object. Validating the decision to bid may include entering and saving the decision and any associated comments and updating the status of the opportunity in the opportunity object.

A Develop Proposal process may include sending a letter of intent to the customer, establishing a mutual bid procedure or competitive framework, identifying contacts, negotiating roles across the enterprise, obtaining certifications (as applicable), estimating BOMs, routings, and other specifics (e.g., taxes), reviewing terms and conditions, monitoring key subcontracts, incorporating the win-theme and business case, compiling proposal contents, and preparing for oral reviews. Sending the letter of intent to the customer may include creating a proposal object, attaching documents to the proposal object, copying RFx documents, and copying the compliance matrix. Obtaining certifications (as applicable) may include attaching documents to compliance matrix line items. Establishing a mutual bid procedure or competitive framework and rules, as well as incorporating the win-theme and business case may include attaching documents. Compiling the proposal content and preparing for oral reviews may include attaching relevant documents.

An Establish Execution Schedule and Pricing process may include estimating BOMs, routings, and other specifics (e.g., taxes), establishing an execution schedule, defining execution positions, defining material components, populating and executing a cost model, and reviewing cost, schedule, and resource variables. Establishing execution schedule may include creating the execution schedule and importing the execution schedule. Defining execution positions may include searching for positions, assigning positions to execution schedule activities, and exporting the execution schedule to project management application 24c.

A Submit Proposal process may include completing the compliance matrix, developing a proposal cover letter, reviewing the proposal, and submitting the proposal package to the customer. Completing the compliance matrix may include checking/updating the compliance matrix. Developing the proposal cover letter may include attaching documents to the proposal object. Reviewing the proposal may include updating the proposal status in the proposal object.

A Conduct Oral Review process may include conducting orals (e.g., a presentation and/or question-and-answer session), responding to questions from the customer, waiting for the customer decision, and conducting a proposal “lessons learned” session. Conducting orals may include updating the proposal status of the proposal object. Responding to questions from the customer may include attaching documents to the proposal object. Conducting a proposal “lessons learned” session may include attaching documents to the proposal object.

A Revise/Rework Proposal process may include negotiating/renegotiating a contract, revising/reworking proposal content, revising execution WBS, revising the cost model, revising the teaming agreement, revising the execution schedule, reviewing the cost schedule and resource variables, and resubmitting the proposal. Negotiating/renegotiating the contract may include attaching documents to the proposal object and updating the proposal status. Revising/reworking proposal content may include attaching documents to the proposal object. Revising execution WBS may include attaching documents to the proposal object. Revising the execution schedule may include updating the external execution schedule and importing the updated execution schedule. Revising the cost model and revising the teaming agreement may include attaching documents to the proposal object. Resubmitting the proposal may include attaching documents and updating the status of the proposal in the proposal object.

A Close out Contract process may include waiting for the customer to respond. If the contract is lost, the loss may be processed and a loss review may be conducted. Processing a loss may include updating the status and attaching documents. Conducting a loss review may include attaching documents. If the contract is won, the win may be processed, a win review may be performed, a kick-off meeting may be conducted, and an execution handover may be performed. Processing a win may include updating the status and attaching documents. Conducting a win review may include attaching documents.

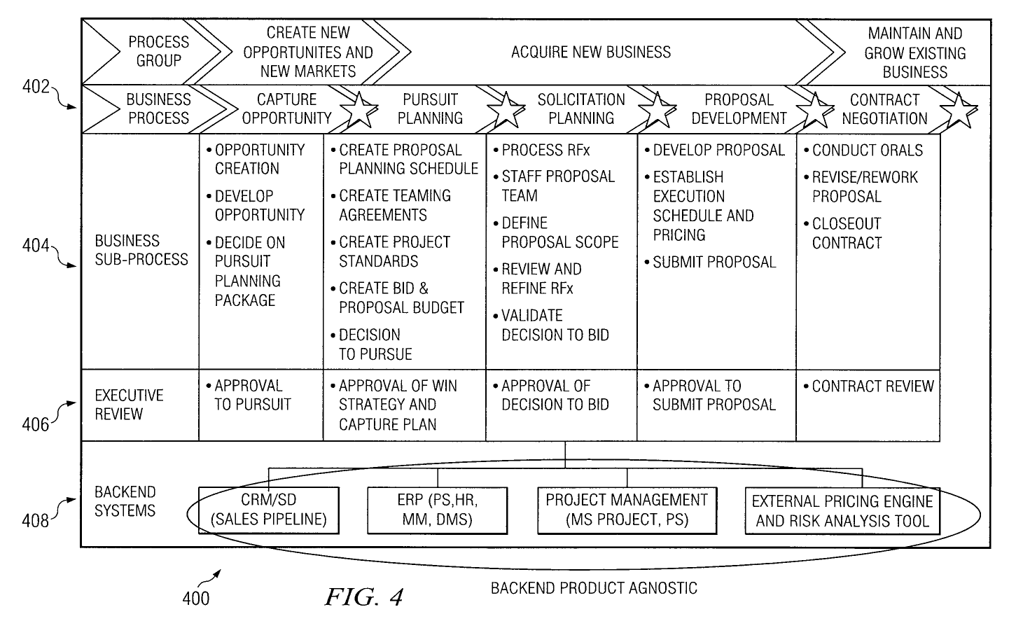

FIG. 4 illustrates another view 400 of an example process for a business acquisition management solution, according to certain embodiments of the present invention. BAMS tool 28 may implement this process.

Five high-level business processes are shown at layer 402 of view 400. In this example, these five high-level business processes are the Capture Opportunity process, the Pursuit Planning process, the Solicitation Planning process, the Proposal Development process, and the Contract Negotiation process. Various sub-processes for the five high-level business processes are shown at layer 404 of view 400. Each of the five high-level business processes may be followed by an executive review, as shown at layer 406 of view 400. These executive reviews may facilitate documentation of decisions throughout the acquisition process. Layer 408 of view 400 shows a number of example backend services 24 that may be used to perform the various business processes and sub-processes.

BAMS tool 28 may provide a number of benefits to a user of user system 12 (and the associated enterprise). In certain embodiments, BAMS tool 28 removes the ad-hoc approach and mechanics of the capture and proposal development process. BAMS tool 28 may institutionalize the steps of a process for managing the capture and bid-and-proposal process into a streamlined, leading practice, and documented system. BAMS tool 28 may track the identified opportunity, structure the mechanics of the process, and help the business capture team concentrate on the content of a proposal. BAMS tool 28 may help ensure that multiple (if not all) business development groups within an enterprise follow a similar process for identifying and qualifying new business opportunities and use a common methodology for developing responses to solicitations (e.g., RFIs, RFPs, and RFQs). Aligning the business acquisition management activities in a single, repeatable may enable rapid response to emerging opportunities, increases communication between business organizations, and better leverages resources across the enterprise and its partners and suppliers.

In certain embodiments, BAMS tool 28 integrates with backend human resource and supply chain systems to aid in assigning teams and materials and selecting key partners and suppliers. BAMS tool 28 may allow for the creation of resource-loaded proposal and execution schedules, which may be passed between BAMS tool 28 and the backend systems (e.g., backend services 24). This may create a collaborative work environment between internal team members and, partners, and suppliers during the creation of the proposal. As the proposal is develop and execution schedules are developed and refined, BAMS tool 28 may facilitate bridging the external project management application with resources and materials from a backend ERP system and the addition of partner resource contribution. The result of a resource-loaded project plan for proposal development and execution of the solution may lead to more accurate estimates of bid-and-proposal costs and final pricing of the end product.

Although particular methods for managing business acquisitions have been described with reference to FIGS. 2-4, the present invention contemplates any suitable methods in accordance with the present invention. Thus, certain of the steps described with reference to FIGS. 2-4 may take place substantially simultaneously and/or in different orders than as shown and described. Moreover, components of system 10 may use methods with additional steps, fewer steps, and/or different steps, so long as the methods remain appropriate.

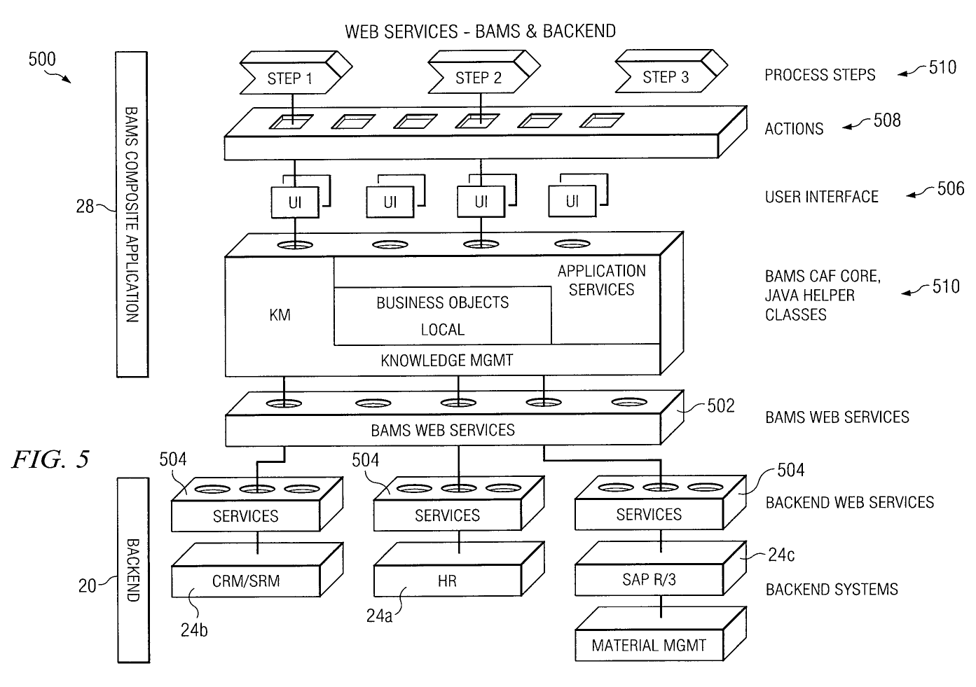

FIG. 5 illustrates an example BAMS logical architecture 500 according to certain embodiments of the present invention. In certain embodiments, interfaces from BAMS tool 28 to existing business systems (e.g., backend systems 24) are enabled through service calls using a web services layer. BAMS tool 28 may include a number of various web services 502, which in turn are operable to communicate with other web services 504 from backend server system 20 (published from backend systems 24). This may keep BAMS tool 28 “backend agnostic,” such that it may be able to operate with a variety of types of backend systems 24 from a variety of vendors.

BAMS tool 28 may expose a UI 506 to user system 12. Users of user system 12 may interact with UI 506 to perform a number of actions 508 corresponding to process steps 510 of the business acquisition process implemented by BAMS tool 28.

BAMS tool 28 may include BAMS deployed code and the SAP NETWEAVER suite. In certain embodiments, BAMS tool 28 uses multiple components within the SAP NETWEAVER platform. For example, one or more of the following components of the SAP NETWEAVER suite may be used: Enterprise Portal, Knowledge Management, Master Data Management, SAP Information Exchange (XI), Business Process Management, web application server (WAS) (e.g., J2EE and ABAP engines), and the composite application framework (on which certain embodiments of BAMS tool 28 is based). In certain embodiments, BAMS tool 28 includes a BAMS CAF Core and one or more JAVA helper classes, as shown at 510. This portion of BAMS tool 28 may include a knowledge management component, one or more application services, and one or more business objects. These business objects may be stored locally to BAMS tool 28.

FIG. 6 illustrates an example object model 600 of example business objects that may be defined for BAMS tool 28, according to certain embodiments of the present invention. Although a particular object model 600 and particular business objects are illustrated, the present invention contemplates BAMS tool 28 being implemented using any suitable object model that includes any suitable business objects.

The following tables include example data elements grouped by object. In certain embodiments, CAF creates this data model and tables automatically based on the object model (e.g., object model 600).

Opportunity

| Field | Comments |
|---|---|
| Opportunity ID | Opportunity number created by the system |
| Customer ID | ID from the back-end ERP system |
| Customer Name | Customer name from back-end ERP system |
| Title | Opportunity title |
| Description | Opportunity description |
| Product Type | Type of Opportunity |
| Revenue | Company's potential to realize the revenue. |
| | This value is rolled up from the line item level |
| B&P Estimated Cost | This value is rolled up from the line item level |
| Labor Cost | This value is rolled up from the line item level |
| Travel Cost | This value is rolled up from the line item level |
| Other Direct Cost | This value is rolled up from the line item level |
| Lead Origination | Origin of Opportunity - lead, phone call etc. |
| Priority | Priority of the Opportunity |
| Start Date | Identification of Opportunity |
| Estimated End Date | Anticipation of closing of Opportunity |
| Business Unit | The business unit responsible for managing this |
| | opportunity |
| Current Status | Status of the Opportunity. This is derived from |
| | business actions or entered by the user. |
| Version Number | Version of opportunity status. |
| | Incremented when rework is performed |
| Status Update Date | The date when the status was updated |

Line Item

| Field | Comments |
|---|---|
| Line Id | Line Item Number |
| Title | Line Item Title |
| Description | Line item description |
| Product Type | Type of product that will be delivered |
| | as a result of this opportunity line item. |
| Currency | Currency of the value |

Assignee (Proposal Team)

| Field | Comments |
|---|---|
| Employee ID | ID from HR back-end - Business Partner Numeric |
| Portal User ID | Employee's corresponding portal login ID. |
| Employee Name | Employee name from the back-end ERP system. |
| | Retrieved from ERP and stored in CAF. |
| First name | Employee first name |
| Last name | Employee last name |
| Position | Employee position in the organization |
| Role Type | Role of the employee. (Proposal Manager or |
| | Capture Manager) |
| Email | Email of the employee |
| Start Date | Estimated start date of the assignment |
| End Date | Estimated end date of the assignment |

Attachment

| Field | Comments |
|---|---|
| Resource ID | Document ID from KM |
| Object ID | Object could be Opportunity or proposal. |
| | This link will be managed in KM. |
| Folder Name | Developed run-time in portal and stored in KM |
| Description | Document description |
| Document Title | Title of the document |

Reviewer

| Field | Comments |
|---|---|
| Employee ID | Same as HR id along with the |
| | designation pulled form the back-end |
| Portal User ID | Employee's corresponding portal login ID. |
| First name | Employee first name |
| Last name | Employee last name |
| Position | Employee position in the organization |
| Email | Email of the employee |
| Decision | Decision of executive. |
| Comments | This field becomes mandatory, |
| | especially when the status field is |
| | checked as disapproved. |

Opportunity Capability

| Field | Comments |
|---|---|
| Capability ID | This capability is selected for the Opportunity |
| Capability Name | Name of the capability |
| Capability Description | Capability description |
| Capability Type | Select from internal or external |

Business Partner

| Field | Comments |
|---|---|
| Vendor ID | ID from the back-end ERP system |
| Vendor Name | Name of the vendor |
| Business Partner | Proposal Manager classified whether the selected |
| Relationship | business Partner is going to be a Vendor or |
| | Partner for this specific Opportunity and for |
| | the specific external capability. |

Status Table

| Field | Comments |
|---|---|
| Status Code | Status Code |
| Status Description | Status Description defined in |
| | configuration of CAF |
| Version | Status version - the version is used |
| | when rework is performed. |

RFx

| Field | Comments |
|---|---|
| RFx Header Key | RFx ID |
| Customer ID | Customer ID, copied form Opportunity |
| Customer Name | Customer Name, copied form Opportunity |
| Solicitation Number | Solicitation number of the RFx |
| Title | RFx Title |
| Description | RFx description |
| B&P Budget | Budgeted cost - copied from |
| | opportunity line items |
| Estimated Revenue | Budgeted revenue - copied from |
| | opportunity line items |
| Status | RFx status |
| Status Since | Status change date and time |
| COTR | Contracting Officer Technical |
| | Representative |
| COTR Contact Number | Contracting Officer's Technical |
| | Representative phone number |
| Contracting Officer | Name of the contacting officer |
| CO Contact Number | Contracting officer's contact number |
| Orals Date | Date on which orals will be conducted |
| Questions Due Date | Date on which the questions are |
| | expected |
| Bidder's Conference Date | Date on which the bidder's conference is |
| | scheduled. |
| Bidder's Conference location | Location of the bidder's conference. |

Compliance

| Field | Comments |
|---|---|
| Compliance Id | Compliance ID |
| Compliance Description | Title of the compliance |
| Status | Indicator to show whether the compliance |
| | item is in compliance or not. This is |
| | based on the compliance at the line item. |
| Compliance Group | Type of compliance |
| RFx Section | Section in RFx that refers to the |
| | compliance |
| Vendor ID | Vendor(s) responsible for compliance |
| Vendor Name | Vendor name |
| Vendor Compliance | Indicator to show whether the vendors |
| | is in compliance or not |
| Vendor Documents | Documents showing the compliance |

Proposal

| Field | Comments |
|---|---|
| Proposal ID | Proposal ID |
| Result | Won or Lost |
| Won By | Name of the firm that wins the award |
| Bid Amount | Amount bid as part of the proposal |
| Status | Proposal status |
| Status Update Date | Status update date |
| Version | Version of the status. Used when rework |
| | is performed. |
| Reason | Reason for win or loss |

Project Schedule

| Field | Comments |
|---|---|
| Project Schedule ID | Project Schedule ID |
| Schedule Type | Proposal or execution schedule |
| Schedule Title | Title of the schedule |

WBS Element

| Field | Comments |
|---|---|
| WBS Element | WBS Number |
| WBS Title | Title of WBS Element |
| Schedule ID | ID of the schedule |
| WBS Level | Level compared to WBS root |
| Parent WBS Element | Parent to which the WBS element is linked |
| Total Cost | Total cost summarized to WBS element |

Activity

| Field | Comments |
|---|---|
| Activity ID | ID of the activity |
| Activity Title | Title of the activity |
| WBS Element | WBS Number |
| Duration | Activity duration |
| Percent Complete | Percent of Completion |
| Early Start | Earlier the activity can start |
| Early Finish | Earliest the activity can finish |
| Late Start | Latest the activity can start without |
| | delaying the project completion |
| Late Finish | Latest the activity can finish without |
| | delaying the project completion |
| Subcontractor Cost | Estimated subcontractor cost |
| Resource Cost | Estimated resource cost |
| Material Cost | Estimated material cost |
| Total Cost | Sum of Subcontractor Cost + Resource |
| | Cost + Material Cost |

Resource

| Field | Comments |
|---|---|
| Resource ID | Resource ID or Position ID |
| Resource Title | Resource name or Position Title |
| First name | First name of the resource |
| Last name | Last name of the resource |
| Resource Source | Internal or external |
| Activity ID | ID of the activity |
| Level of Effort | Total amount of effort needed |
| Percent of Assignment | Percent of time that the resource will |
| | work on a specific activity |
| Labor Rate | Resource rate per hour |
| Amount | Cost of labor |

Material

| Field | Comments |
|---|---|
| Material ID | Material ID |
| Activity ID | ID of the activity |
| Material Unit Rate | Unit rate of the material |
| Material Quantity | Quantity of Material |
| Material Source | Partner or Own |
| Material Amount | Cost of the material |

External Material Master

| Field | Comments |
|---|---|
| Material ID | Material ID |
| Material Description | Material name |
| Vendor Name | Name of the vendor that provides the material |
| Material Unit Rate | Unit rate of the material |
| Unit of Measure | Unit of measurement |

External Resource Master

| Field | Comments |
|---|---|
| Resource ID | Resource ID or Position ID |
| Resource Title | Resource Name or Position Title |
| Vendor ID | Vendor that provides the resource or position |
| Vendor Name | Vendor name |
| Labor Rate | Resource rate per hour |

The data model describe above is provided for example purposes only and should not be used to limit the scope of the present invention.

Although the present invention has been described with several embodiments, diverse changes, substitutions, variations, alterations, and modifications may be suggested to one skilled in the art, and it is intended that the invention encompass all such changes, substitutions, variations, alterations, and modifications as fall within the spirit and scope of the appended claims.

What is claimed is:

1. A system for managing business acquisitions, comprising:
a memory module operable to store information in one or more business objects associated with managing a business acquisition;
a server system comprising a composite application that is operable to provide one or more processes for managing the business acquisition, the composite application providing an integrated solution for managing the business acquisition, the one or more processes comprising:
a capture opportunity process operable to facilitate establishment and approval of an opportunity;
a pursuit planning process operable to facilitate development and approval of a proposal development schedule;
a solicitation planning process operable to facilitate, in response to receipt of a customer solicitation in one of various forms, updating of the proposal development schedule, establishment of a collaborative environment for preparing a proposal for the opportunity, and approval of a decision to bid on the opportunity;
a proposal development process operable to facilitate preparation of content of the proposal for the opportunity; and
a contract negotiation process operable to facilitate finalization of a statement of work for the project,
the composite application being a web-based application and further operable to:
receive, from one or more users associated with the business acquisition, input and documents for the one or more processes; and
facilitate storage of the input and documents for the one or more processes in association with the one or more business objects stored in the memory module.

2. The system of claim 1, operable to provide a user interface for receiving the input and the one or more documents from the one or more users.

3. The system of claim 2, wherein the user interface comprises a plurality of screens for guiding the one or more users through the one or more processes provided by the composite application.

4. The system of claim 1, wherein the one or more processes of the server system are interfaced with one or more backend services and are operable to interact with the one or more backend services to facilitate execution of the one or more processes of the composite application.

5. The system of claim 4, wherein the one or more backend services are heterogeneous.

6. The system of claim 4, wherein the one or more backend services comprise one or more of the following:
a human resources system;
a customer management system;
a project management system;
a financial system; and
a materials/purchasing system.

7. The system of claim 4, wherein the one or more processes of the server system interface with the one or more backend services using a web services layer.

8. The system of claim 1, wherein each of the one or more processes comprises a review and approval phase.

9. The system of claim 1, operable to control access to the system according to one or more roles assigned to the one or more users of the system, the one or more roles comprising one or more of the following:
a business manager role comprising a responsibility for identifying and capturing opportunities from one or more leads;
a capture manager role comprising one or more of the following responsibilities:
winning qualified opportunities;
developing relationships with customers; and
providing business-related guidance to a proposal team;
a proposal manager role comprising a responsibility for leading the proposal development process with a proposal development team;
a proposal team role comprising a responsibility for supporting one or more tasks of the proposal development process, the one or more tasks comprising one or more of writing content, collecting qualifications, maintain partner relationships, and pricing;
an executive role comprising a responsibility for providing oversight and reviewing contents of a proposal after each of the one or more processes; and
a partner/vendor role comprising a responsibility for providing proposal content based on a scope of work identified in a partner or vendor contract.

10. The system of claim 1, wherein the one or more business objects comprise one or more of the following:
an opportunity object for storing input and documents associated with the opportunity;
an RFx object for storing information regarding a received RFx;
a proposal development schedule object for storing input and documents associated with the proposal development schedule; and
a proposal object for storing input and documents associated with the proposal.

11. The system of claim 1, wherein the composite application is implemented using an SAP NETWEAVER platform.

12. A computer-implemented process for managing business acquisitions, comprising:
in a capture opportunity phase for qualifying a lead into an opportunity:
establishing an opportunity; and
determining whether to approve the opportunity;
in a pursuit planning phase, if it is determined that the opportunity should be approved:
developing a proposal development schedule; and
determining whether to approve the proposal development schedule;
in a solicitation planning phase performed in response to receiving a customer solicitation in one of various forms (an “RFx”):
updating the proposal development schedule based on the RFx;
establishing a collaborative environment for preparing a proposal for the opportunity; and
determining whether to bid on the opportunity;
in a proposal development phase, preparing, if it is determined to bid on the opportunity, the proposal for the opportunity; and
in a contract negotiation phase, finalizing a statement of work for the project;
the process being performed using a server system (for example, a web services system) comprising:
a memory module storing information in one or more business objects associated with managing a business acquisition; and
a web-based composite application that receives input and documents for the one or more processes from one or more users associated with the business acquisition and facilitates storage of the input and documents in association with the one or more business objects stored in the memory module.

13. The process of claim 12, wherein each phase of the process is followed by an executive review for seeking approval to advance to a next phase and for documenting decisions throughout the process.

14. The process of claim 12, comprising defining one or more roles for performing one or more of the phases, the one or more roles comprising one or more of the following:
a business manager role comprising a responsibility for identifying and capturing opportunities from one or more leads;
a capture manager role comprising one or more of the following responsibilities:
winning qualified opportunities;
developing relationships with customers; and
providing business-related guidance to a proposal team;
a proposal manager role comprising a responsibility for leading the proposal development process with a proposal development team;
a proposal team role comprising a responsibility for supporting one or more tasks of the proposal development process, the one or more tasks comprising one or more of writing content, collecting qualifications, maintain partner relationships, and pricing;
an executive role comprising a responsibility for providing oversight and reviewing contents of a proposal after each phase of the process; and
a partner/vendor role comprising a responsibility for providing proposal content based on a scope of work identified in a partner or vendor contract.

15. The process of claim 12, wherein the capture opportunity phase comprises:
a create opportunity phase that comprises one or more of the following:
creating an opportunity; and
assigning one or more roles to the opportunity;
a develop opportunity phase that comprises one or more of the following:
establishing a bid and proposal budget;
developing a business case for the opportunity;
developing a win themes and capture strategy for the opportunity; and
identifying one or more of internal capabilities and external capabilities for pursuing and fulfilling the opportunity; and
a pursuit planning determination process that comprises one or more of the following:
assigning one or more executives to the opportunity;
routing information regarding the opportunity to the one or more executives assigned to the opportunity for review;
collecting feedback from the one or more executives; and
making one or more executive decisions regarding a state of the opportunity.

16. The process of claim 15, wherein the pursuit planning phase comprises:
a create proposal schedule phase that comprises one or more of the following:
importing a proposal schedule from a project management application;
allowing one or more team members assigned to the opportunity to review the proposal schedule;
assigning one or more resources to the proposal schedule;
exporting a resource-loaded schedule to the project management application;
a create project standards phase that comprises establishing one or more standards and procedures for the proposal;
a teaming phase that comprises one or more of the following:
selecting one or more partners and suppliers;
establishing one or more non-disclosures agreements and teaming agreements;
updating the win themes and capture strategy for the opportunity; and
attaching one or more documents to the opportunity;
a create bid and proposal budget phase that comprises one or more of the following:
setting a bid and proposal budget for the opportunity; and
assigning one or more resources to the opportunity; and
a pursuit decision phase that comprises one or more of the following:
determining whether to continue pursuing the opportunity; and
determining whether to revise one or more decision-related steps.

17. The process of claim 16, wherein the solicitation planning phase comprises:
an RFx processing phase that comprises managing an RFx from a customer by:
acknowledging receipt of the RFx; and
entering information regarding the RFx;
a proposal team staffing phase that comprises one or more of the following:
identifying one or more competencies for producing a proposal for the RFx and to fulfill the proposal for engagement requirements;
finalizing resource assignments;
updating the resource assignments in a human resources system;
updating the project plan;
developing a compliance matrix for tracking the resource requirements; and
enabling a collaboration environment for the proposal for use by the proposal team;
an RFx review and refinement phase that comprises reviewing and refining the RFx; and
a validate decision to bid phase that comprises determining whether to continue to pursue the opportunity by developing the proposal.

18. The process of claim 17, wherein the proposal development phase comprises:
generating a proposal object
associating relevant documentation with the proposal object;
finalizing roles and responsibilities;
a schedule execution and pricing phase that comprises one or more of the following:
establishing an execution schedule for developing the proposal;
assigning materials and resources for developing the proposal;
performing cost modeling for developing the proposal; and
developing pricing for execution of developing the proposal; and
a proposal submission phase that comprises one or more of the following:
developing a proposal cover letter;
completing a compliance matrix;
completing a review of the proposal prior to submission of the proposal;
incorporating feedback from review teams;
determining whether to clear the proposal for submission; and
if it is determined that the proposal is clear for submission, submitting the proposal.

19. The process of claim 18, wherein the contract negotiation phase comprises:
a discussions phase that comprises discussing the proposal with the customer and accessing documents stored in the system;
a statement of work production phase that comprises developing and refining, in response to being selected for the proposed work, a statement of work; and
a contract closeout phase that comprises performing one or more activities after a contract is won or lost.

20. The process of claim 12, comprising accessing one or more user interface screens provided via the server system for performing the various phases of the process.

21. Software for managing business acquisitions, the software comprising a composite application embodied in a computer-readable medium and when executed operable to:
store information in one or more business objects associated with managing a business acquisition;
provide one or more processes for managing the business acquisition, the software providing an integrated web-based application for managing the business acquisition, the one or more processes comprising:
a capture opportunity process operable to facilitate establishment and approval of an opportunity;
a pursuit planning process operable to facilitate development and approval of a proposal development schedule;
a solicitation planning process operable to facilitate, in response to receipt of a customer solicitation in one of various forms, updating of the proposal development schedule, establishment of a collaborative environment for preparing a proposal for the opportunity, and approval of a decision to bid on the opportunity;
a proposal development process operable to facilitate preparation of content of the proposal for the opportunity; and
a contract negotiation process operable to facilitate finalization of a statement of work for the project.
the software further operable to:
receive, from one or more users associated with the business acquisition, input and documents for the one or more processes; and
facilitate storage of the input and documents for the one or more processes in association with the one or more business objects stored.

22. A system for managing business acquisitions, comprising:
a memory module operable to store information in one or more business objects associated with managing a business acquisition;
a server system comprising a composite application that comprises an integrated web-based solution for managing the business acquisition that is operable to:
communicate information to one or more user systems to guide users associated with the user system through one or more processes for managing the business acquisition, the information comprising one or more screens and data associated with the business acquisition process;
receive, from the one or more users systems, input and documents for the one or more processes; and
facilitate storage of the input and documents for the one or more processes in association with the one or more business objects stored in the memory module.
